(19) United States
(12) Patent Application Publication
(10) Pub. No.: US 2015/0317356 A1
(43) Pub. Date: Nov. 5, 2015

(54) COMMUNICATIONS UTILITY WITH INTEGRATED MAPPING GRID

(71) Applicant: Brett Alan Deichler, Kansas City, KS (US)

(72) Inventor: Brett Alan Deichler, Kansas City, KS (US)

(21) Appl. No.: 14/270,217

(22) Filed: May 5, 2014

(51) Int. Cl. G06F 17/30

(52) U.S. Cl. CPC G06F 17/30418; G06F 17/30554

(57) ABSTRACT

An electronic notification protocol using both proprietary and open-source architecture to improve emergency search outcomes and enhance the probability of locating a missing person by privately registered system users and emergency support personnel. A series of electronic, copyrighted database files and forms support and expedite both the registered data files and the required communication workflow via standard computer networks and mobile peripheral devices. An electronic mapping component is also utilized to depict the most likely elopement locations based upon historical statistics and proprietarily integrated algorithms, while specific signage icons can be embedded into the electronic mapping grid to identify relative risk scenarios surrounding the most probable elopement locations. The application core is a system of integrated web services and proprietary software coding dictating data authentication, access, logic, configuration, user interface control, third party data translation, and relational communications. A historical tracking log also provides real-time communication updates to registered participants.

### CROSS-REFERENCE TO RELATED APPLICATIONS

By this publication, I, Brett Alan Deichler, the inventor, do hereby claim priority filing status to Provisional Application No. 61/820,011, Confirmation Number 9842, and EFS I.D. 15704370, as previously filed with the United States Patent and Trademark Office (USPTO) on May 6, 2013, at 17:59:58 Easter Standard Time (EST).

### STATEMENT REGARDING FEDERALLY SPONSORED RESEARCH OR DEVELOPMENT

Not Applicable

### BACKGROUND OF THE INVENTION

As stated above in the Cross-Reference to Related Applications Section, by this publication, I, Brett Alan Deichler, the inventor, do hereby claim priority filing status to Provisional Application No. 61/820,011, Confirmation Number 9842, and EFS I.D. 15704370, as previously filed with the United States Patent and Trademark Office (USPTO) on May 6, 2013, at 17:59:58 Eastern Standard Time (EST).

1. This invention relates to an integrated communications program that was proprietarily developed as a base utility element, and an integrated mapping grid. More particularly, this invention relates to specific development coding that enables end-users to establish and/or locate persons and objects on a dynamic mapping grid and report information to other registered users in a real-time format. More particularly, this invention utilizes specific development coding to enable end-users to establish and/or locate dynamic objects, or people, on a dynamic mapping grid by using proprietarily integrated software codes, proprietarily developed registration and data processing forms, statistical and business modeling and projection forecasts that are statistically developed from historical performance data, and both proprietary and non-proprietary open-source (prior art) software solutions to improve overall location time and the success rates of both emergency and non-emergency search personnel.

2. Of recent, there are various software programs (prior art) claiming to locate an individual device (e.g. mobile phone, tablet) by using global positioning systems (GPS) to identify a specific location and/or mapping coordinates. Unfortunately, these services fail to accurately identify the device due to the inability of the technology to communicate accurately. More importantly, these devices often fail because they only consider the initial search and location services by applying a common GPS format. Unfortunately, these current platforms do not consider the utilization of any historical data trends/elements, mathematical algorithms and statistical relationships, or real-time communication services, that assist the search personnel with real-time information and data driven elements to improve the overall time and frequency of success.

3. This invention utilizes a proprietary software framework to initialize the search protocol, utilizes proprietarily copyrighted registration and processing forms, and utilizes real-time statistical data elements to effectively coordinate, assign and track search efforts, to accurately communicate relevant information, including dangerous locations or most probable areas, to the end-users in both the desktop and mobile peripheral environments. This invention also integrates proprietary and non-proprietary software solutions (e.g. Google Earth, mobile cellular triangulation) to expedite authenticated data communications between any/all approved/registered information recipients.

4. Through the use of certified log-in (personal identification software) and multiple bi-lateral communication platforms, the web-enabled utility quickly shares/communicates critical data elements throughout the network to enhance/engage real-time geospacial tracking agents, interactive mapping grids, historical tracking logs, front-end/back-end notification elements, automated call-outs and after-action reporting requirements.

5. As designed, the web-enabled user interface (UI) can quickly send notification alerts to emergency service providers (e.g. police, fire), social media outlets (e.g. Facebook, Twitter), family/friends/personal contacts, and free-form text messages to non-smartphone devices using an open switch. The proprietary solution actively integrates with on-site legacy systems, assets and devices to diminish and remove disparate communication applications/processes throughout the organization.

6. Some of the proprietarily developed, non-obvious and novel business elements surrounding our integrated information share include (but are not limited to):
Historical Tracking Log with real-time data applications, chronological reporting, data warehouse updates, automated closeout requests, etc. This information is reported in a bi-lateral configuration to the active users, emergency responders, and personal trackers. This information is also proprietarily integrated with the Proprietary Client-Facing User's Template as depicted and defined in FIG. 7. The Historical Tracking Log and integrated mapping solution are considered version 1.0 at this date and time, with a projected date for fully-integrated technologies during FY 2013.
Integrated mapping grid components with geospacial service updates, integrated mapping overlays, proprietary routing elements, artificial intelligence/knowledge tree iteration, and statistical grid modeling depicting mapping components and probability ratios.
Enhanced business intelligence (BI) applications utilizing metadata, data mining, and content merging & migration techniques are deployed to measure and improve functional operations, organizational efficiencies, resource allocations and real-time updated communications.
Proprietary enterprise reporting agent, including after-action reports, depicts subject tendencies, logistical solutions and lessons learned.

7. This business solution has also created a proprietary United States Mapping Grid that includes/utilizes a series of unique search codes, prefixes and mapping components. This business element was developed to assist/support the current/proposed National First Responders requirements in reference to the projected changes in the D Block communication business environment.

8. The integrated, pro-active business model creates tools to improve operational performance and effectively merge public/private communications, while the back-end utility creates a baseline for future growth and enhances public image as a leader in IT/integrated solutions to meet citizens/community needs.

9. In addition, the primary wandering (Zap City Missing Persons Alert©) application was designed to notify various layers around the missing subject. The automated application also alerts assigned teams that the missing subject has eloped or wandered away. If the absence is prolonged, greater layers of authorized searchers are advised and/or added as the search circle widens.

10. The proprietary software suite also provides integrated mapping components and/or application layers to identify pre-determined hot spots or danger zones for the wanderer or eloper. For example, but not limited to, the system creates and/or depicts the most probable location(s) based upon historical data, high-voltage or electrical areas, bodies of water, overpasses, or heavy traffic areas.

11. The integrated software stack and user templates (e.g. Zap City Elopement Alert Form©, Proprietary United States Mapping Grid©, Unique Search/Event Code User's Template©) also provides; current photos and pertinent identifiers of the missing subject, provides updated contact information for assigned and/or authorized caretakers, identifies all relevant medical information (medications, doctors, hospital), subject tendencies and preferences (i.e. tends to run/elope in certain direction, fear of bright lights/noises, combative), and provides a brief history of previous elopement scenarios.

12. The mapping component also provides an integrated business solution supported by proprietarily developed algorithms, statistical relationships, tendencies, and other business intelligence models, which is overlaid and/or integrated with open-source mapping API's to create a proprietary grid report for the end user/authorized event participants and an automated dispatch algorithm/electronic notification for the registered first responder/emergency support agencies.

13. In addition, this product already supports a fully-integrated, social-media rich web-based business solution that delivers/creates an instant notification protocol, utilizes real-time mapping components and historical tracking logs, and leverages acquired business intelligence models for both real-time updates and back-end reporting services.

### BRIEF SUMMARY OF THE INVENTION

1. This invention utilizes a proprietary software framework to initialize the search protocol, create and leverage real-time statistical data elements to effectively coordinate search efforts, and accurately communicate relevant information to the end-users in both the desktop and mobile peripheral environments. The goal of the initial release was to provide a proprietary software framework for registering applicants, and, initializing, communicating, and coordinating a physical search for a missing person, quite often with cognitive disabilities, utilizing digital communication, geographic display and tracking, and social media via a unified digital control point. The control point was implemented as a conjunction of database and web services. As a search is initialized via one of several implemented interfaces, utilizing various mobile peripherals such as, but not limited to, web, iPhone, Android, and windows phone applications, the web services will provide access to:
Database recording, user information, and search history;
Coordination with social media and digital communications;
Geographic location tracking, search scope and coordination;
Intelligent monitoring of preselected hazards, history, and crowd sourced search information.

2. The base of the application is a database backend tracking the registered users information, missing subject information, contact lists, social media connection information, geo specific user information and configuration, and geo-positional search history, including previously activated searches and corresponding histories. The backend consists of a relational SQL (sequel) database with supporting tables, stored procedures, and relational indices. Each participant in the search is stored as a user in the database, and, is logged in the database as a history with geo-positional mapping coordinates along with any submitted comments, data, or media. Additional information obtained via social media is stored as a third party data submission in the database via a web service interface translating the given media into database specific format. Finally, user and system logic supplied search directions are logged in a historical format for analytics, documentation, and to provide efficacy to future searches for the same subject.

3. The application core is a system of web services dictating data access, logic, configuration, user interface control, and third party data translation. The web services communicate and transfer data via xml formatted data packets, which can be converted directly to object relational code or database ready format, dependent on the web service and given command. The majority of logic, application control, and data processing will reside in this layer, or section of the system. The database is responsible for storage and retrieval of data relating to the system, whereas the user interface is a means of providing direction and input to the system; the web service layer provides command and control while off-loading processing to the network of servers.

### BRIEF DESCRIPTION OF THE DRAWINGS, FIGURES & DIAGRAMS

FIG. 1 illustrates a static, basic outline view of the base mapping component for this invention;

FIG. 2 illustrates the interactive, electronic mapping component, that also used alpha-numeric components to define the individual mapping grid areas, that is utilized by the independent computers and devices for this invention;

FIG. 3 illustrates current examples of the proprietary symbols utilized to depict various elements which are located on the mapping grid for this invention;

FIG. 4 depicts the proprietarily developed—copyrighted Proprietary United States Mapping Grid© for this invention;

FIG. 5 depicts the copyrighted Zap City Proprietary United States Boundary Map©, and the individual State boundaries, on a United States map, and also illustrates the individual numbers by State as assigned to the proprietary mapping grid prefix codes;

FIG. 6 depicts the copyrighted Unique Search/Event Code (User's template© for this invention;

FIG. 7 illustrates the copyrighted client-facing, proprietary Zap City Elopement Alert Form© that is utilized by the end-user as a formal registration template for this invention;

FIG. 8 illustrates the copyrighted mobile peripheral device icon (Zap City Primary Business Icon©) that directly connects the end-user to the proprietary business website for this invention;

FIG. 9 illustrates the mobile peripheral device icon that directly connects the end-user to the integrated MAPPING COMPONENT for this invention;

FIG. 10 illustrates the copyrighted mobile peripheral device icon (Zap City Emergency Alert Icon©) that directly connects the end-user to the MISSING PERSON ALERT software application and components for this invention;

FIG. 18 illustrates the proprietary Architectural Workflow Diagram that is utilized to connect any/all hardware/software applications for the Zap City Missing Person Alert process;

FIG. 19 illustrates the Zap City Multi-Contact Messaging Platform that directly connects the end-user to the proprietary software solutions;

FIG. 20 illustrates the proprietarily developed Zap City Missing Persons Alert Mobile Application Landing Page which includes business artwork, website layout and/or specific business tabs that proprietarily connect the registered user to the desired functions;

FIG. 21 illustrates the proprietarily developed initial log-in page that requires the registered user to submit their username, password, and phone number to access the proprietary software application and/or create a formal search notification;

FIG. 22 illustrates the proprietary functionality of the Zap Alerts tab in respect to creating a formal system alert, sending updates and/or alerts to social media outlets, or creating a formal notification that the missing person (e.g. child, family member, friend) has been found/located;

FIG. 23 illustrates the proprietarily developed Send Alert landing page which notifies the registered user that they are preparing to create/send and official search notification to other registered system users;

FIG. 24 illustrates the proprietarily developed Select the Child landing page that allows the registered user to select/identify the relevant missing person for which the formal search notice will be created;

FIG. 25 illustrates the proprietarily developed Update Profile Info landing page which allows the registered user to update any/all proprietary or personal information about the missing person prior to creating and sending a formal search notification;

FIG. 26 illustrates the proprietarily developed Update Info landing page which allows the registered user to update the height and weight, or include a photo or video, of the missing person prior to creating/sending a formal search notification;

FIG. 27A illustrates the proprietary Location landing page which allows the registered user to either (a) utilize the default address/location that was created at the time of initial registration, or, (b) allow the registered user to use free-form text, drop-down boxes, and other demographic elements, to create a new and/or current address/location prior to creating the integrated mapping component as depicted in FIG. 27B;

FIG. 27B illustrates the proprietarily integrated mapping grid that is created and electronically distributed as part of the emergency alert notification to the registered users via email, and other communication processes, once the registered user identifies the preferred location as outlined in the preceding FIG. 27A description;

FIG. 28 illustrates the proprietarily developed Update Location landing page that allows the registered user to identify the current and/or preferred location by using both free-form text and integrated drop-down solutions to identify the new location prior to creating the integrated mapping solution;

FIG. 29 illustrates the proprietarily developed Alert Message landing page that notifies the registered user that a formal alert notification is being sent, and also allows them to add free-form text statements to the message prior to sending;

FIG. 30 illustrates the proprietarily developed Alert Message Sent landing page that confirms that the registered user's emergency search notification was successfully sent;

FIG. 31 illustrates the proprietarily developed City Grid landing page that allows the registered user to identify the preferred search location and/or include a preferred search radius prior to creating the integrated mapping solution and/or sending a formal search notification;

FIG. 32 illustrates the proprietarily developed Events landing page which allows the registered users to access any/all information pertaining to upcoming Zap City LLC business events;

FIG. 35 illustrates the proprietarily developed More landing page which allows the registered user to share the mobile application through email and/or social media connections, register for Zap City LLC's newsletter using email, or create an integrated—interactive United States mapping grid by adding the preferred location;

FIG. 36A illustrates the proprietarily developed Zap City LLC mobile application workflow processes that are available to the registered user when accessing and/or utilizing the Zap Alerts tab from the landing page as depicted in FIG. 20;

FIG. 36B is a continuation of the workflow from FIG. 36A that illustrates the proprietarily developed Zap City LLC mobile application workflow processes that are available to the registered user when accessing and/or utilizing the Zap Alerts tab from the landing page as depicted in FIG. 20;

FIG. 40 illustrates the proprietarily developed Zap Pics landing page which allows the registered user to either, (a) create/take a photo and/or video using the current device and subsequently upload the information to the Zap City notification website, or, (b) allow the registered user to locate and/or utilize an existing photo and/or video already located on the specific device to upload the information to the Zap City notification website;

FIG. 41 illustrates the second Zap Pics landing page that allows the registered user to select an existing photo/video from the current device, or allows them to create a new photo/video with the current device prior to uploading the information to the Zap City notification website;

FIG. 42 illustrates the proprietarily developed Share landing page that allows the registered user to share the information by email, Facebook, Twitter, etc.;

FIG. 43 illustrates the generic email example of the Share Email landing page that is presented to the registered user when the Share Email function is selected. The registered user can utilize the email form to either, (a) send a formal notification using the standard default language, or, (b) create a new message using free-form text prior to sending the email notification;

FIG. 44 illustrates the proprietarily developed Share Facebook landing page that is utilized by the registered user to log-in to their personal Facebook account(s) and share the information;

FIG. 45 illustrates the proprietarily developed Share Twitter landing page that is utilized by the registered user to log-in to their personal Twitter account(s) and share the information;

FIG. 46 illustrates the proprietarily developed Zap Mail landing page that allows the registered user to sign-up for Zap City's electronic newsletters;

FIG. 47 illustrates the proprietarily developed Around Us landing page which allows the registered user to create a customized United States Mapping Grid that can be utilized by the proprietary Zap City Mobile Application to create an assigned search protocol for a specified geographic area;

FIG. 48 illustrates an example of the proprietarily developed Integrated Zap City Emergency Notification Message that is electronically created using the proprietary hardware/software elements, proprietarily integrated business workflow model, and any/all copyrighted documents to create an interactive search notification to any/all registered users that are proprietarily selected by the registered sender;

FIG. 49 illustrates the proprietarily developed Formal Zap City Email Registration Notice that is generated and delivered to the registered user to confirm receipt of their initial registration with Zap City LLC;

As depicted herein, FIG. 50 illustrates the cell tower triangulation theory/methodology that is utilized in today's industry to locate a specific device when an electronic signal is received by 1 cellular tower;

As depicted herein, FIG. 51 illustrates the cell tower triangulation theory/methodology that is utilized in today's industry to locate a specific device when an electronic signal is received by 2 separate cellular towers;

As depicted herein, FIG. 52 illustrates the cell tower triangulation theory/methodology that is utilized in today's industry to locate a specific device when an electronic signal is received by 3 separate cellular towers;

### DETAILED DESCRIPTION AND BEST MODE OF IMPLEMENTATION

1. The invention can be implemented in numerous ways, including as a process; an apparatus; a system; a composition of processes; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘process’ refers to one or more devices, circuits, and/or processing cores correctly aligned and configured to process data, such as computer program instructions or electronic communication transferals.

2. A detailed description of one or more embodiments of the invention is provided below along with accompanying figures that illustrate the principles of the invention. The invention is described in connection with such embodiments, but the invention is not limited to any single embodiment. The invention also utilizes existing open-source technologies and/or prior art (e.g. biometrics, triangulation services, open-source tracking, mobile pings, global positioning systems) to complete the electronic communication processes. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in complete granular detail so that the invention is not unnecessarily obscured.

3. To reference the invention in greater detail, the utility's workflow methodology is a fully integrated, enterprise-wide dynamic solution that utilizes a utility based development application to integrate and support proprietary software elements and solutions. The utility based application is dynamically integrated with current technology platforms (e.g. middleware, software stacks, social media resources, xml scripting), including integration with various open-source application programming interface (API) connections, to create an interactive, real-time product environment for both the private constituent and the end-user in both the private and public business domain.

### Business Model/Integrated Workflow (Exploded Component View)

### Communication Workflow, Technology, and Integrated Hardware/Software Components

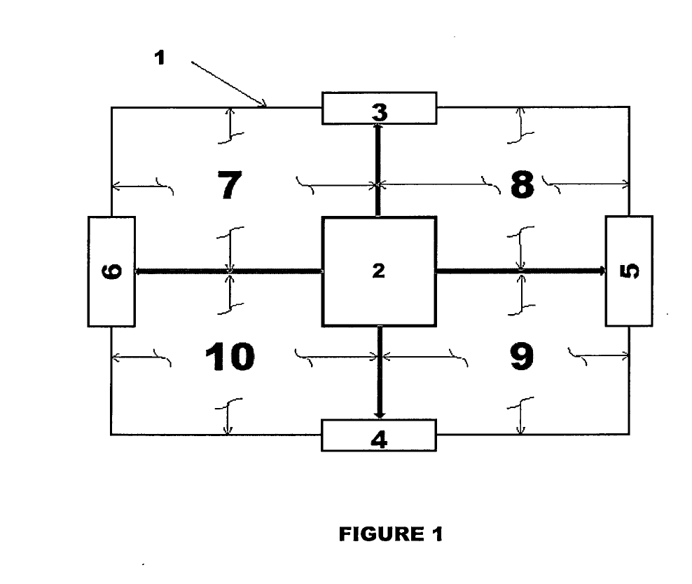

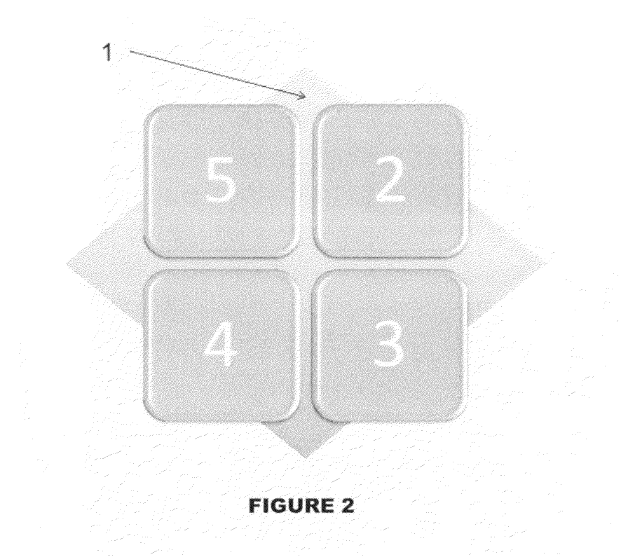

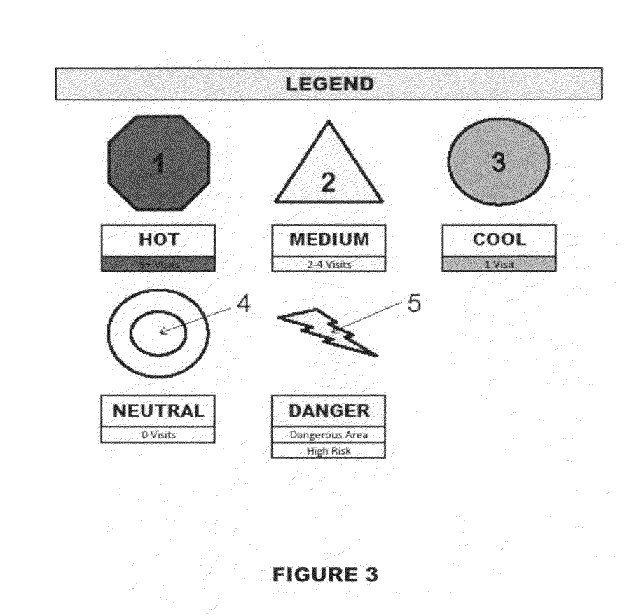

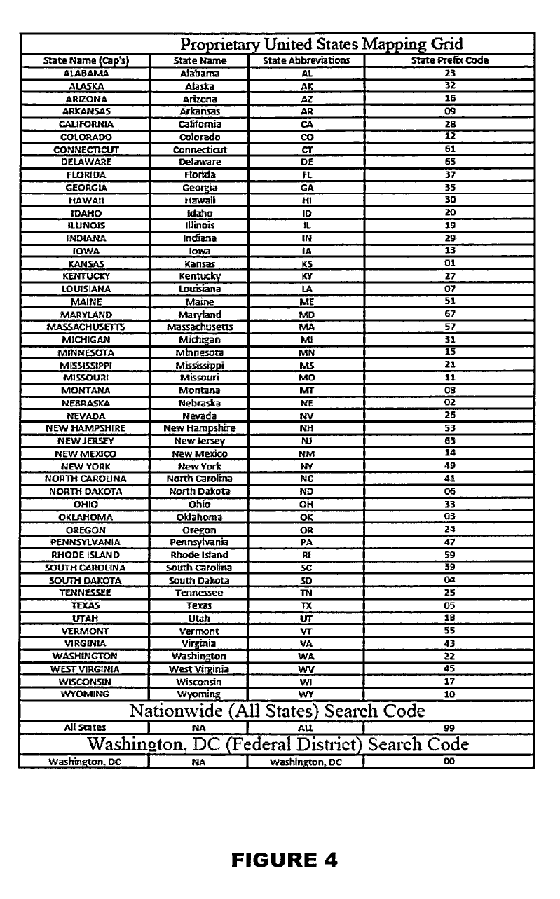

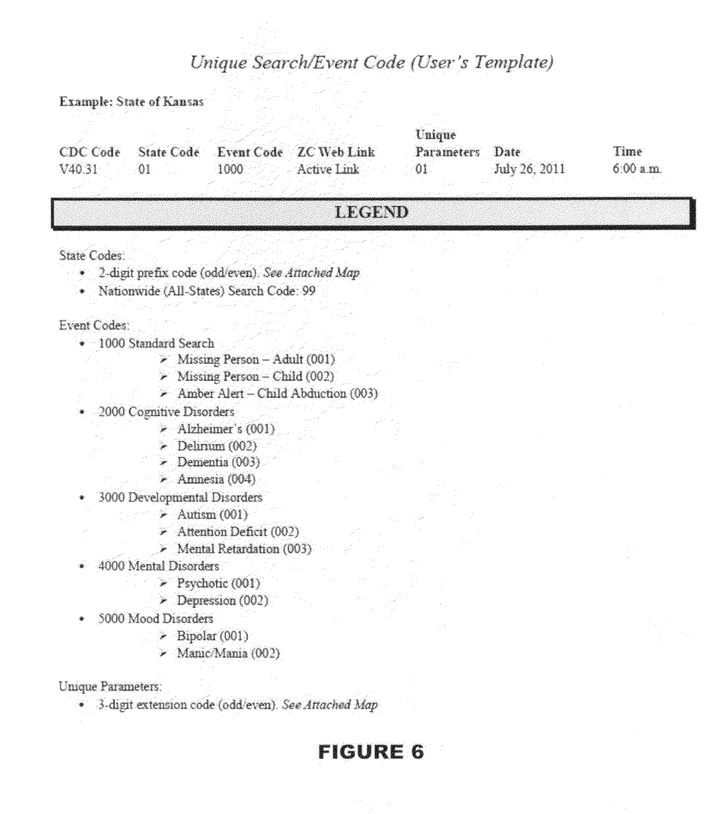

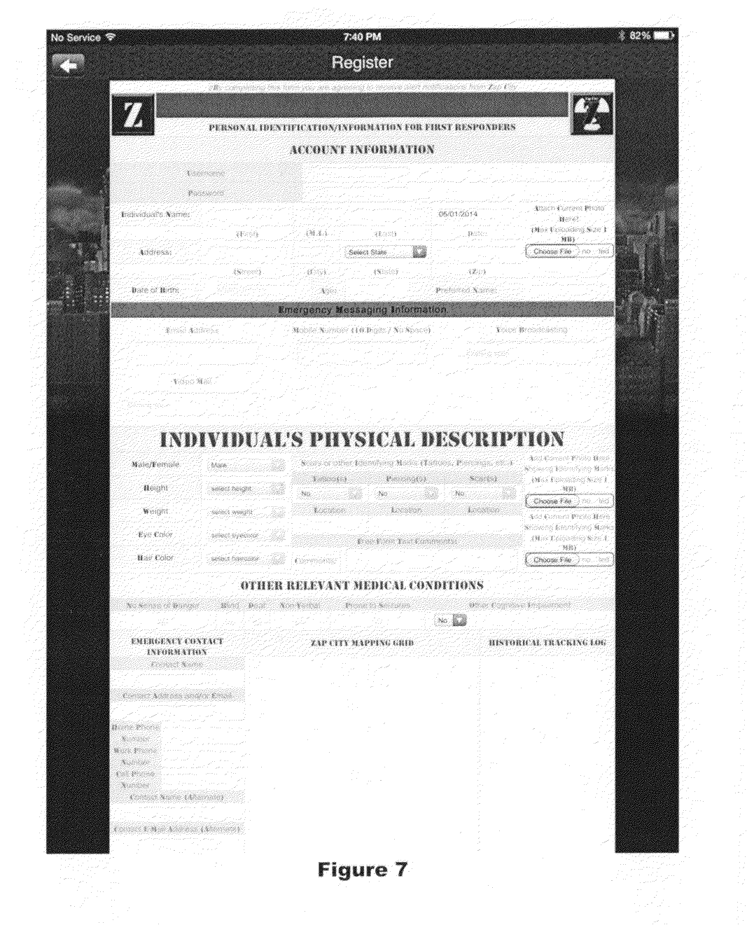

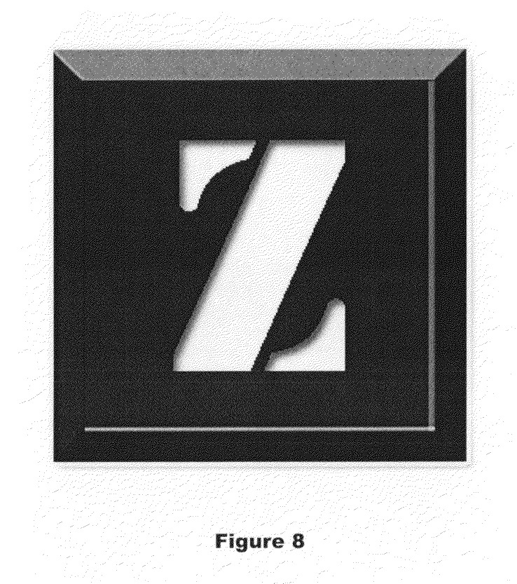

Biometric Fingerprint Sensor Software—Authenticated User Sign-On (Prior Art)
Proprietary Zap City Software Icons Downloaded to Mobile Peripheral Devices & Computers
Proprietary Client-Facing User Templates (e.g. Zap City Missing Person App©, Zap City Elopement Alert Form©) Downloaded to Mobile Peripheral Devices, Computers, Mobile Website & Servers
Mobile Peripheral Devices & Computers (Hardware/Software)
Integrated Web Hosting/Web Service Environment
Web-Hosted Database on Dedicated Server w/Static IP Address: Database Server Houses Static/Dynamic Mapping Components (FIGS. 1 & 2), Proprietary Symbols (FIG. 3), Proprietary United States Mapping Grid© (FIG. 4), Unique Search Events Codes Template© (FIG. 6), Zap City Elopement Alert Form© (FIG. 7)

### Integrated Web Services Environment/Content Data Network

### Hardware/Software Application Details

Business Website:

The corporate website is a full-sized, social media-rich business website that also serves as the primary location for the distribution of general information, proprietary content and application software. The proprietary Zap City Elopement Alert Form and/or client-facing user registration template, as depicted and defined in FIG. 7, will also be managed and distributed from the primary website as a means to secure, update and back-up any/all relevant user content through an integrated cloud service environment.

Database Server Environment:

The database server environment will house any/all applicable data content generated as part of the dynamic communication exchange of the software components. Both ad-hoc and custom reporting profiles will be established as a means to effectively report the data content to the end user.

The database environment will house information that is proprietarily developed as part of the integrated software application(s) (e.g. Static/Dynamic Mapping Grids & Components (FIGS. 1 & 2), Proprietary Mapping Grid Symbols (FIG. 3), Proprietary United States Mapping Grid© Configuration (FIG. 4), Unique Search Events Codes Template© (FIG. 6), and the Zap City Elopement Alert Form© (FIG. 7). These applications will use both unilateral and bi-lateral communication feeds to support the data content, as well as the functional requirements of the businesses utility model and/or workflow methodology.

Audio/Video Server Environment:

The audio/video environment serves as a proprietary protocol for adding audio and video content together, separately, or individually. The audio/video server will allow the end user to record an audio message and/or create a video (or static photo) as depicted and described in FIG. 15, the proprietarily developed Audio/Video/Photo Communication Flash software, and deliver it to any/all active search participants, or push the content to the end user's previously identified contact listing using social media delivery, electronic notifications, or email.

Email & Text Messaging Server Environment:

Both the email and text messaging server environment will control the integrated email and text message services and/or all automated email and texting features as proprietarily designed. The email and text service will send content to all smart and non-smart mobile phones and mobile/wireless peripheral devices. These services may also be delivered through an open-switch environment.

Notification Server Environment:

The primary service environments communicate simultaneously, when required, and due to their proprietary integration formats, have the ability to communicate independently with individual wide area network (WAN) and local area network (LAN) servers, or deliver proprietary content to the end-user upon request.

### Integrated Biometric Identification System & Authenticated Data Models

### Fingerprint-Sensor Authentication

Please note: to protect the personal identification of the individual user, missing person(s), professional authority of the recipients, and authenticated integrity of the data and communication files, these applications may or may not require any/all users, search participants, and information recipients to preliminary identify themselves using various mobile biometric solutions prior to receiving access to the proprietary software suite.

Using strong mobile device authentication technology can reduce the risk of sensitive information, or privileged data, falling into the hands of a malicious user. One of the strongest technology options on today's market is the use of biometric mobile authentication. By embedding the technology into the proprietary software products listed herein, the system will add an additional layer of protection to the user's device to secure the protected content.

Until recently, biometrics was typically utilized by the military to secure physical access to locations and facilities. And by comparison, single-factor authentication methods were too easy to break. As a result, companies have started to review the cost benefits of two-factor solutions such as biometrics. Unfortunately, biometric data, like other data resources, must reside on a physical server which opens the possibility of infiltration from hackers if not properly secured and hardened. Therefore, it is absolutely critical that any biometric product transmits data securely (using encryption) from the biometric reader back to the authenticating server.

At this time, our system will utilize a two factor authentication process to identify any/all user requests to enter the system. By definition, two-factor authentication is best described as something you have plus something you know. For example, something you know can consist of PIN Codes or passwords, where as something you have may consist of a hardware token that can be synchronized with the system. As expected, the two-factor methodology is a little more complex than the standard one-factor technologies, but in return, provides a significant increase in security. Fortunately, the second factor can also be something you are—which as expected, can be the most reliable biometric element to date—the human fingerprint or the human eye. In fact, biosensor technology is starting to utilize various fingerprints (from the same person) to allow access to multiple applications such as email messaging, banking or financial institution data, or mobile applications. In the case of our software suite, this would allow the user to first authenticate their identity to permit access to the software suite. Secondly, this process would allow the now identified and authorized user to create a formal search request using a second fingerprint, or using a third fingerprint to access information from the proprietary Zap City Elopement Alert Form© as depicted and defined in FIG. 7.

Since fingerprint recognition, and the human eye serves as the two-best personal identifiers, and can seamlessly work with any/all IT solutions, one of these technologies may or may not become the system of choice for engaging these proprietary applications as defined herein.

### Historical Tracking Log w/Bi-Lateral Communications

The Historical Tracking Log will serve as a real-time update/bulletin board to advise authorized search personnel about the current status of the pending search. The Historical Tracking Log is actively integrated with Area 410 on the proprietary Zap City Elopement Alert Form© (as depicted and defined in FIG. 7) and includes any/all relevant information about the active search or searches that are being conducted. The Historical Tracking information is stored & published in chronological order and when using a mobile device, the user can scroll up and down the page by swiping the screen or widening the form.

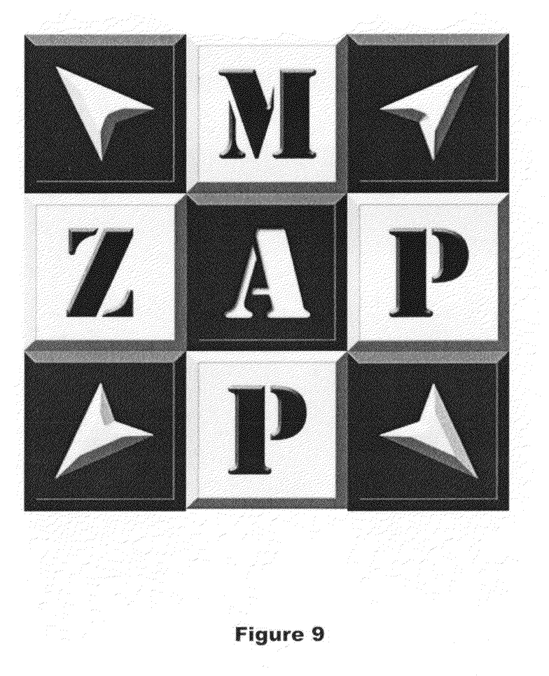

The primary website, which is typically accessed by using the icon in FIG. 8, or by searching/entering www.zap-city.com on the internet, utilizes a proprietarily developed Dot.Net (ASP) version of the template (Zap City Elopement Alert Form©) that would be completed by the end-user, as depicted and defined in FIG. 7, prior to the assignment of an authorized (official) search notification. With a desktop computer system, or mobile device, the user could access the host website to engage the full Dot.Net (Sequel 2008) version of the Zap City Elopement Alert Form © template. Once the user completes the necessary information in the template, the document and information can be saved to the host database and utilized as the primary information and/or communication components when the end user creates and/or authorizes an official search.

A mobile version of the Zap City Elopement Alert Form© was also developed using MySQL, php5, and other technologies, as a means to minimize the overall file size, and as a result, accommodate both speed and agility in the mobile peripheral work environment. Using a mobile device, the user can access the mobile version of the Zap City Elopement Alert Form© template online to add/delete/change any required information prior to authorizing a formal search notification and/or posting a communication to any/all authorized search participants. The mobile website will also be synchronized with the actual online business website to exchange and/or update data more efficiently.

Both ad-hoc and customized reporting models can be developed by a database analyst (DBA) or business analyst (BA), or similarly trained person, to report the critical data that was published by the Historical Tracking Log during a live search event. The Historical Tracking Log will also integrate with the proprietarily developed software applications as depicted and defined in FIGS. 2, 4, 6, 7, 8, 9, and 10. The proprietarily integrated communication assignments of the Historical Tracking Log will utilize both unilateral and bilateral communication links to depict the desired tracking information.

### Integrated Mobile Tracking Services

### Cellular Triangulation/Global Positioning System (GPS)/Mobile Location Pings

The following information shall identify/outline the open-source tracking architecture and/or prior art that is utilized in today's open market to locate and identify mobile peripheral devices. The following language shall also identify and define the initial software suite, integrated software stack, and utility-based architecture as developed by the applicant, and shall comprise a portion of the businesses intellectual assets. Albeit, some of the proprietary applications will actively integrate with existing open application programming interfaces (API's) that are currently being utilized in today's active infrastructure, all proprietary code, business processes, methodologies, algorithms, logic and reporting schemes shall remain the intellectual property of the applicant and/or corporation.

As briefly mentioned, the following applications as defined and depicted herein, shall identify both the technical specifications/requirements and the specific workflow that is utilized to create the most effective and efficient communication profiles across the integrated business model.

### Open-Source Tracking Architecture

In general, the technology of locating a device is based on measuring power levels and antenna patterns while the powered device communicates (wirelessly) with one (or more) of the closest base stations which would imply that the device is nearby.

Advanced communication systems determine the sector (typically a 120 degree area) in which the mobile device resides then utilizes these variables to estimate the actual distance to the base station. Greater estimates can be obtained by interpolating between multiple adjacent antennas and/or towers.

Mobile phone tracking refers to the relative location and identification of a mobile telephone, or mobile peripheral device, whether the device is stationary or in motion. Localization may occur either via multilateration of radio signals between (2 or more) radio towers residing on the host network and the mobile device, or simply through the engagement of the Global Positioning System (GPS Satellites) which will be explained in greater detail later in this publication.

To locate the phone using multilateration of radio signals, the telephone must emit, at a minimum, a roaming signal to contact any/all cellular towers (antennas) within range. Since all mobile devices broadcast a constant radio signal, even when not on a call, and, since the Global Systems for Mobile (GSM) network is based on the signal strength to nearby antenna masts the process does not require an active call to identify the relative position or coordinates of the mobile device.

Mobile positioning, which includes location based services that discloses the actual coordinates of a mobile device bearer, is a technology used by telecommunication companies to approximate where a mobile phone or device, and most often, its user/bearer, temporarily resides.

Localization-Based Systems can be Broadly Divided into:

Network-based techniques utilize the service provider's network infrastructure to identify the location of the handset. The accuracy of network-based techniques varies, with cell identification as the least accurate, cellular triangulation as moderately accurate and forward-link timing methods as the most accurate. Unfortunately, the accuracy of network-based techniques is both dependent on the concentration/density of base station cell towers, with urban environments achieving the highest possible accuracy, and the implementation of the most current timing methods.

One of the key challenges of network-based techniques is the requirement to work closely with the service provider, as it entails the installation of hardware and software within the operator's infrastructure. As of this publication, one proposed work-around is the installation of embedded hardware or software on the handset by the manufacturers, e.g. Enhanced Observed Time Difference (E-OTD). This avenue has not made significant headway, due to the difficulty of convincing different manufacturers to cooperate on a common mechanism and to address the cost issue. Another difficulty would be to address the issue of foreign handsets that are roaming in the network.

### Operational Purpose

In order to route calls to a mobile telephone, the cell towers listen for a signal sent from the telephone and negotiate which tower is best able to communicate with the mobile device. As the telephone changes location, the antenna towers monitor the signal, and the phone is continuously roamed to an adjacent tower whenever required.

By comparing the relative signal strength from multiple antenna towers a general location of a mobile telephone can be roughly determined. Newer devices may also allow the tracking of the device even when turned on and not active in a telephone call.

With today's current technology, a mobile telephone's location can be identified and the information can be uploaded to a common website where someone can view the devices last reported position. Newer devices may have built-in GPS receivers that can be utilized in similar fashion, but with much higher accuracy.

In most occurrences, this process proves controversial because having this data posted on a common website may mean that people who are not authorized may be able to view the information, most obviously, the owners of the site. Fortunately, the proprietary Zap City Missing Person's© software suite, as developed and defined herein, requires all assigned participants to certify their identity and/or be pre-authorized prior to posting/receiving any/all confidential communications or relevant information. Information pertaining to this certification requirement is specifically outlined later in this publication under the heading of Zap City Website, Mobile App & Database Architecture—Business Concept, Process Workflow, & Active Integration Model.

Cell Tower Triangulation is accomplished when utilizing 2 or more cellular antennas and/or towers. In today's technology, these towers have 3-segments (resembling a triangle at its center) that are equally divided into 120 degree segments. These segments are commonly referred to as alpha, beta and gamma.

At the time a signal is received within the sector, the tower can measure the relative distance of the transmission, or in most cases, the cellular device or phone. This is accomplished by measuring signal strength and the round-trip signal time. For various technical reasons, the measurement, when acquired from a single tower, will have a significant error band which renders the single-tower location method somewhat inaccurate in comparison to other active technologies (e.g. GPS).

To effectively examine the accuracy of a single tower's architecture, let's assume that the 3-segments on the cellular tower have a radius of 6 miles to the edge of the arc (12 mile diameter across the bands over the 360 degree radius). Note, at a radius of 6 miles the 120 degree arc is approximately 12.6 miles in length along the circumference.

As depicted in FIG. 50, if a signal is received (in the Gamma sector) that is 4 miles away from the tower's antenna, the location for this signal would fall within an area ranging approximately 8.4 miles in length (along the 4 mile radius arc per 120 degree segment), with approximately a ½ mile bandwidth, that when calculated, creates an area of approximately 4.2 square miles in coverage. As a result, the approximate area for this signal and/or device would fall within this range/arcing bandwidth which is somewhat large in comparison to other location technologies being used today.

### Please Insert FIG. 50 Here

In continuation, let's assume that the mobile device is simultaneously negotiating with a second tower as depicted in FIG. 51. As part of the triangulation base logic, the accuracy of the devices location improves as additional towers/signalization is added to the equation. For example, let's assume that a signal that is 4 miles away from Tower 1 is being received in the Gamma sector, and the same signal is being received by Tower 2 at 6 miles away in the Alpha sector. Through further analysis, this would establish the device signal in the oval whose center is the intersection where the swept areas of the two towers' approximate distance bands overlap.

### Please Insert FIG. 51 Here

In continuation, if a third tower is added to the equation (as depicted in FIG. 52) and receives a signal that is 6 miles away, the area of location can be estimated even more closely. But, it should be understood that the mobile device must be negotiating with all 3 towers to triangulate the more accurate signal location.

In densely populated urban areas, the cell towers are typically closer together which allows the device location to be estimated more closely than in rural areas where these towers are usually farther apart. Also, newer mobile devices can actually report a GPS location that (a) does not require a cellular tower/antenna to calculate distance and location, or (b) is typically more accurate than previously utilized technologies.

### Please Insert FIG. 52 Here

### Global Positioning System (GPS) & Global Positioning System Satellites (GPSS)

Global Positioning Systems (GPS) is a worldwide radio-navigation system formed from the constellation of 24 (primary) satellites and 3 reserve (back-up) satellites. The GPS is mainly funded and controlled by the United States Department of Defense (DOD) and was initially designed for military operations. But, with today's expanding technologies, civilian users are allowed to utilize the standard service without charge or restrictions.

GPS tracking is utilized to track exactly where an object (or person) will be by utilizing mobile GPS devices/receivers that locate the device/object whether static or in motion. These devices can allow followers to receive real-time updates about the location and progress of vehicles, or family members in transit.

From a basic perspective, a GPS tracking system uses the Global Navigation Satellite System (GNSS) network. This network incorporates a range of satellites that utilize microwave signals that receive/transmit information to GPS enabled devices to identify relative location, speed of object, time and direction. The GPS satellite signals are processed by a receiver to compute these ever-changing variables, and when utilizing a minimum of 4 satellites, can compute 3-dimensional configurations.

The Space Segment of the GPS architecture utilizes 24 primary satellites that circle the Earth every 24 hours, and 3 additional satellites that serve as immediate back-up in the case of failure. In addition the Space satellites, the control system utilizes various tracking stations across the globe to monitor (receive) the microwave signals prior to statistical conversion. The operation of the system is based upon the trilateration mathematical principle which typically speaking, is divided into two primary categories: 2-D and 3-D Trilateration.

To make the necessary mathematical conversions, the GPS receiver must know (a) the location (as defined by the satellites) and (b) the distance between the object's location (on Earth) and the satellites in Space. The radio waves are electromagnetic in nature and travel at the speed of light which allows for the ease of receipt and conversion by the receiving units.

Two forms of GPS tracking are utilized in today's commercial technology environment; passive systems which use the devices hardware capacity (e.g. internal memory card) to store the historical data for later downloads, and active (real-time) systems that send the information to a centralized database (e.g. via modem) within the GPS network.

### Mobile Location Pings

In discussing the previous technologies for locating the relative proximity for mobile devices, I wanted to identify another possible technology that may exist in today's technological society. As part of our previous discussions, the science of triangulation (analog process) was detailed as a method for the cellular networks to locate a mobile device that is connected to their network. In addition to triangulation, a method commonly referred to as pinging the device has been discussed in numerous online forums. By urban definition, pinging is a digital process that can locate a mobile device, with reasonable accuracy, at any given point in time by utilizing the device's GPS location hardware/software. More specifically, a ping would send a signal to a particular device and require the device to respond with the requested data, and in this case, it would be the location and/or position of the device.

By federal law (E-911), today's mobile service providers, and all mobile devices, are required to become GPS capable so emergency personnel can locate the position of the signal (or caller) in the state of an emergency. For example, when a new digital cell phone is pinged, it determines the latitude and longitude of the device through GPS and communicates these coordinates back through the systems network via the SMS system (the same system that is used to send text messages). With older style analog devices, or digital mobile devices that are not GPS capable, the cellular network provider can still utilize triangulation to determine where the device is as previously defined.

### Primary (Static) Zap Map w/Boundaries and Sectors

### Reference Diagram—FIG. 1

FIG. 1 depicts an integrated mapping component with geospacial service updates, integrated mapping overlays and intelligence, proprietary routing elements, and statistical grid modeling to depict mapping components and probability ratios. FIG. 2 depicts the dynamically-integrated (electronic) mobile version of the same principles listed in FIG. 1, with the exception of creating a dynamic application or solution that integrates with web and application programming interfaces, mobile peripheral devices such as wireless/mobile telephones, tablets and personal computing devices. The dynamic mapping component also integrates with and/or utilizes streaming audio & video content, open-source global positioning satellite systems (GPSS), receivers and processors, feedback correction systems & feedback loops, navigation algorithms, database structures & schemas, architectural networks, servers, and packet structures/content.

FIG. 1 depicts an example of the mapping grid 1 having four sectional areas 7, 8, 9, 10 on the mapping grid. These sectional areas are defined by the user, and would typically define a north, south, east and west boundary, but can be established by the user to define any identifiable boundary line that surrounds a pre-defined area/sector or central point-of-location on the map.

Using FIG. 1 as an example, but not necessarily limited by this example, a person could use their home address as the central point-of-location 2 and establish the four North/South/East/West boundaries 3, 4, 5, 6 respectively, at any preferred distance from the central point-of-location as desired. The numbers of defined areas/sections can range from “0”, meaning that the central point-of-location serves as the only mapping parameter, or can include 1 defined area, which would include a specific geographical area showing a central point-of-location and a North/South/East/West boundary as defined by the user, or can include an infinite number of mapping segments that would include a central point-of-location with a North/South/East/West boundary that surrounds the geographical area as defined by the user.

By design, the mapping component provides emergency responders, and other public/private persons, with a grid map that allows searchers to break the area(s) into defined geographic grids to ensure the search is managed in the most efficient/effective manner. This will allow emergency responders and other search teams/persons a listing of the most significant and/or dangerous hot spots that may pose a threat to the missing person. Unlike the limitations of just using cellular triangulation, mobile pings, or global positioning systems to estimate the location, this novelty of the proprietary Zap City LLC mapping grid also provides emergency responders and other searchers with the preferred routes of travel and destinations, enabling searchers to conduct a more intelligent and efficient search by using open-source mapping components, static and dynamic GPS coordinates, and proprietarily developed and integrated algorithms and mathematical vectors.

These components, combined with other relative processes and integrated technologies, contribute to a much improved, novel search protocol. As an example, but not limited to, the algorithms and statistical trend analysis modules are embedded into both the reporting models and individual icons (as assigned) and as a result, are overlaid/integrated into the proprietarily developed mapping components as discussed in FIGS. 1 & 2 to create/assign individually automated search roles and responsibilities to actively assigned/registered searchers. The active searchers use both automated and integrated call-outs that engage triangulation methods to estimate the actual arrival times at specific locations on the mapping grid in FIG. 1.

The issue with current law enforcement processes and policies is most often, when a search for a missing person is requested, the officers tend to respond to the location where the subject went missing, then simply begin circling the address (or central point-of-location) for lack of a better method or procedure. By using our integrated mapping grid, the caretaker, or legal guardian, has already provided the pertinent information, by various methods of communication, prior to dispatching of law enforcement, emergency and personally selected or approved search personnel. This information is immediately accessible to searchers, and the systematic search, based upon the historical habits or tendencies of the missing person as identified by the embedded statistical models can commence immediately. This eliminates the opportunity of wasting valuable time by trying to gather enough information to create an effective/efficient search protocol.

The proprietary Zap City Elopement Alert Form© template, as preliminarily completed by the user at the time of initial registration, will be discussed in greater detail herein. But, it should be noted that the caretaker and/or legal guardian controls the authorized release and flow of information which provides both a novel and distinct advantage by creating improved processes and workflow at the beginning, middle and end of the search, and also improves communications and search updates throughout the search cycle, and protects individual privacy when required. This application also includes an audio and video software segment that allows the end user, or emergency responders, to send the audio/video content to any/all active users, or any/all emergency support personnel (e.g. Police, Fire) who are located on the primary mapping grid.

### Please Insert FIG. 1 Here

### Primary (Dynamic) Zap Map w/Boundaries and Sectors

### Reference Diagram—FIG. 2

FIG. 2 depicts the mapping grid 1 as a fully-interactive, dynamic software solution. The four sectional areas 2, 3, 4, 5 represent the four sectors as defined in the previous example, but as previously stated, the number of sectors for this model can range from “0” to an infinite amount based upon the users preferences. The integrated version will allow the user to click the sectors tab with a mouse, or touch the screen with their hand on any mobile device to activate the technology. The active technology will allow the user to add, delete, or change any proprietary elements on the mapping grid such as the effective boundary lines, the central point-of-location, signage and/or identification labels, create/enter new statistics into the user profile or template, or recall any past historical information from the database. The integrated mapping component will also allow the user to utilize the geographical coordinates from the open-source mapping API's to identify the available routes between any number of locations on the mapping grid. The open-source API mapping component will also integrate with the mapping section as depicted and defined in FIG. 7, the proprietary Zap City Elopement Alert Form© template, to allow the user to either select the original default address as listed in FIG. 7, or select the current GPS location as the default location prior to authorizing a formal search notification.

In addition, the dynamic mapping layer will actively integrate with the remaining software stack and/or proprietary applications as depicted and defined in FIGS. 1, 2, 8, 9, and 10. The proprietarily integrated workflow model will utilize both simple and advanced mathematics (e.g. trigonometry, geometry, vector analysis, multivariate calculations, statistical analysis & probability ratios) to examine the effective business profiles, then identify and report the preferred response for the end user based upon the proprietary code requests.

Algorithms and trend analysis (statistical probabilities) are embedded into the assigned icons as depicted and defined herein, and are actively integrated with the mapping components to create and/or assign search roles/responsibilities to active/authorized search and notification personnel. The proprietary Travel Application, as depicted and defined in FIG. 11, will utilize both advanced and pre-programmed call-out structures to estimate current location(s) and the projected arrival times specific locations. Triangulation, GPS and other known open-source technologies, as previously outlined, will be utilized to support these functional requirements.

### Please Insert FIG. 2 Here

### Legend Showing Zap Map Icons

### Reference Diagram—FIG. 3

FIG. 3 represents, but is not limited to, some examples of signage icons that can be added, embedded or assigned to the mapping grid in FIG. 1 to identify areas of concern. For example, but not limited to, FIG. 3 shows a stop sign 1 that would represent a hot spot, meaning that the missing person would have visited this location at a minimum of five times prior to the current search/incident. The triangle 2 represents a medium-risk, or at least 2-4 visits from the missing person, the circle 3 represents a cool-risk, meaning that the missing person has only visited the location once before the current incident. The double-circle 4 represents zero previous visits from the missing person, but can be added as a future place of concern by the user.

Other icons and/or signage can be added or embedded to the map to determine the relative risk factors for the missing person, and to assist in improving both the probability of early rescue and the response and/or recovery time of the search. As an example, but not limited to, the lightning bolt 5 represents a high-risk area (danger) of high-voltage or electrical shock. This icon could be added to represent an electrical sub-station in the mapping area. Other icons such as, but not limited to, water (e.g. creeks, lakes, rivers), highways (e.g. roadways, dangerous passages, elevated surfaces), can be added to the mapping grid to determine the relative risk factors for the pre-defined search area. Open-source API's using mapping overlays, proprietary algorithms, and applied mathematics can also be added or embedded to support the information and communication exchanges for any/all active-search parties. As a secondary example, but not limited to, the mapping overlay as depicted and defined in FIGS. 1 & 2 can be integrated/activated with the remaining applications to show all police and fire stations on the mapping grid, and their relative locations by address including specific driving directions, or to identify all active and non-active police, fire and emergency service personnel within a pre-defined area or jurisdiction. Proprietary algorithms and mathematical vectors have been calculated and embedded into the host mapping grid as depicted and defined in FIGS. 1 & 2 to assist the automated call-out notifications, activity requests, and travel time calculations of the integrated business model and/or established processes.

Please note; statistical risk models have also been developed to identify the probability ratios for any/all locations on the map. Thus, allowing any/all active search parties to effectively coordinate their search efforts and mitigate the amount of risk on a location-by-location basis based upon the best probabilities.

### Please Insert FIG. 3 Here

### Proprietary United States Mapping Grid© Depicting State Name, Prefix Code(s), Event Code(s), Unique Parameters, Date & Time, including Nationwide & Washington, D.C. Search Codes

### Reference Diagram—FIG. 4

FIG. 4 represents the copyrighted, Proprietary United States Mapping Grid© 1 that identifies each state by state name 6, state abbreviation 7, and a proprietary state prefix code 8. A proprietary code has also been developed to create a Nationwide (all states) search 3, and a specific code was developed to proprietarily search/support Washington, D.C. 4.

By alphabetical order, the individual state prefix codes are listed by State Name (Capital Letters) 5, State Name 6, State Abbreviations 7, and State Prefix Code 8 as follows:

| | | | |
|---|---|---|---|
| ALABAMA | Alabama | AL | 23 |
| ALASKA | Alaska | AK | 32 |
| ARIZONA | Arizona | AZ | 16 |
| ARKANSAS | Arkansas | AR | 09 |
| CALIFORNIA | California | CA | 28 |
| COLORADO | Colorado | CO | 12 |
| CONNECTICUT | Connecticut | CT | 61 |
| DELAWARE | Delaware | DE | 65 |
| FLORIDA | Florida | FL | 37 |
| GEORGIA | Georgia | GA | 35 |
| HAWAII | Hawaii | HI | 30 |
| IDAHO | Idaho | ID | 20 |
| ILLINOIS | Illinois | IL | 19 |
| INDIANA | Indiana | IN | 29 |
| IOWA | Iowa | IA | 13 |
| KANSAS | Kansas | KS | 01 |
| KENTUCKY | Kentucky | KY | 27 |
| LOUISIANA | Louisiana | LA | 07 |
| MAINE | Maine | ME | 51 |
| MARYLAND | Maryland | MD | 67 |
| MASSACHUSETTS | Massachusetts | MA | 57 |
| MICHIGAN | Michigan | MI | 31 |
| MINNESOTA | Minnesota | MN | 15 |
| MISSISSIPPI | Mississippi | MS | 21 |
| MISSOURI | Missouri | MO | 11 |
| MONTANA | Montana | MT | 08 |
| NEBRASKA | Nebraska | NE | 02 |
| NEVADA | Nevada | NV | 26 |
| NEW HAMPSHIRE | New Hampshire | NH | 53 |
| NEW JERSEY | New Jersey | NJ | 63 |
| NEW MEXICO | New Mexico | NM | 14 |
| NEW YORK | New York | NY | 49 |
| NORTH CAROLINA | North Carolina | NC | 41 |
| NORTH DAKOTA | North Dakota | ND | 06 |
| OHIO | Ohio | OH | 33 |
| OKLAHOMA | Oklahoma | OK | 03 |
| OREGON | Oregon | OR | 24 |
| PENNSYLVANIA | Pennsylvania | PA | 47 |
| RHODE ISLAND | Rhode Island | RI | 59 |
| SOUTH CAROLINA | South Carolina | SC | 39 |
| SOUTH DAKOTA | South Dakota | SD | 04 |
| TENNESSEE | Tennessee | TN | 25 |
| TEXAS | Texas | TX | 05 |
| UTAH | Utah | UT | 18 |

By proprietary design, the Nationwide (all states) search code, as listed under the State Name (Capital Letters) 5, State Name 6, State Abbreviations 7, and State Prefix Code 8 will be labeled as follows:
ALL STATES All States All 99

By proprietary design, the Washington, D.C. (Federal District) Search Code, as listed under the State Name (Capital Letters) 5, State Name 6, State Abbreviations 7, and State Prefix Code 8 will be labeled as follows:
Washington, D.C. Washington, D.C. Washington, D.C. 00

Based upon these proprietary search codes, the user will be able to retrieve both ad-hoc and customized reports pertaining to current (open) searches by state, nationwide, or in Washington, D.C. The user can also utilize statistical modeling to identify current areas of concern such as, but not limited to, process and performance, regionalization issues, or identify best practices by reviewing and reporting current/past after-action reports as filed by the individual(s).

### Please Insert FIG. 4 Here

### United States Mapping Grid & Prefix Codes; Displayed on North American/State Map

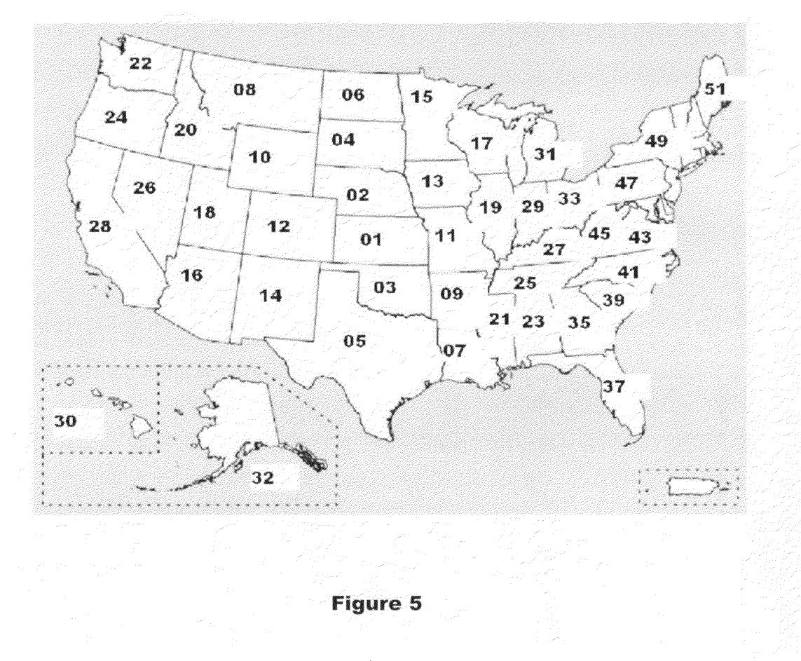

### Reference Diagram—FIG. 5

FIG. 5 depicts the individual states on the Zap City Proprietary United States Boundary Map© according to their proprietarily developed and assigned state prefix code(s) as reported earlier in FIG. 4. The mapping component shown in FIG. 5 will be integrated as part of the support templates and/or communication workflow for this technical business model, and will also be available electronically as a static snapshot of the proprietary U.S. mapping grid.

### Please Insert FIG. 5 Here

### Unique Search/Event Code (User's Template)© Includes CDC, State Prefix Codes, Event Codes, etc

### Reference Diagram—FIG. 6

FIG. 6 represents a proprietarily developed Unique Search/Event Code User's Template© 1 that includes the following information and/or relative search criteria:
The primary header on the Unique Search/Event Code User's Template© has sections that allow the user to enter the individual state name, Washington, D.C. location, or all states name 2, in free-form text to identify the proprietary state prefix code(s) for the desired search area. The header also allows the user to enter free-form text values for the effective CDC code(s) 3, individual state prefix code(s) 4, proprietary Event Code(s) 5, or a Unique Parameter code(s) 6. The header will automatically populate the date in section 8, and the time in section 9, using both open-source and actively-integrated technologies, and time/date technologies that already exists on the individual device(s) or personal computers. The individual state prefix code(s) can either be entered as free-form text by the user, or can be automatically populated when the user enters the appropriate state name/code in section 2. The template also works in reverse where section 2 automatically populates when the user enters an applicable state prefix code in section 4 by free-form text.
For further example; as detailed in FIG. 4, FIG. 6 would allow the user to enter the individual state name, all states name request, or Washington, D.C. name request in section 2 on the template to identify the preferred state(s) or desired area;
Again, referencing FIG. 6, section 3 represents the United States Center for Disease Control's (CDC) ICD-9-CM diagnosis code for wandering in diseases classified elsewhere (V40.31). This code was recently adopted by the CDC (Oct. 1, 2011) and is used to describe the effects of wandering as a disease. The Unique Search Template 1 described in FIG. 6, utilizes this newly adopted code to effectively track and develop statistics, and effectively identify and communicate relevant data and/or real-time or historical information, as it relates to any/all wandering classifications.

FIG. 6, section 4 utilizes the proprietarily developed and assigned state prefix code(s) to track and report information from any/all specific states, or on a Nationwide basis if requested. As previously mentioned, the state prefix code(s) can either be added by free-form text by the user or will automatically populate when the users enters the appropriate state name in section 2 on the template.

FIG. 6, section 5 represents a proprietarily developed and assigned event code that directly identifies the specific type of search being requested or conducted. The proprietary event code is a 4-digit number that represents either a standard search protocol, a cognitive disorder search protocol, a developmental disorder search protocol, a mental disorder search protocol, or a mood disorder search protocol. This proprietary event code allows the search responders to immediately identify the type of disorder (or normalcy) of the lost subject prior to engagement after the subject is physically located.
This proprietary 4-digit event code number in section 5 is immediately followed by a proprietary 3-digit number that identifies the specific type of search being conducted or requested as a subset of the higher event code 4-digit classification. The proprietary 4-digit event codes in section 5, and the proprietary 3-digit unique parameters in section 6 were developed to identify the dependent relationships of each disorder (or normalcy) and are proprietarily defined as follows:
Event Code: 1000 Standard Search
   Missing Person—Adult (001)
   Missing Person—Child (002)
   Amber Alert—Child Abduction (003)
Event Code: 2000 Cognitive Disorders
   Alzheimer's (001)
   Delirium (002)
   Dementia (003)
   Amnesia (004)
Event Code: 3000 Developmental Disorders
   Autism (001)
   Attention Deficit (002)
   Mental Retardation (003)
Event Code: 4000 Mental Disorders
   Psychotic (001)
   Depression (002)
Event Code: 5000 Mood Disorders
   Bipolar (001)
   Manic/Mania (002)
When using the Unique Search/Event Code information in FIG. 6, users and search responders will be able to utilize information gathered from the database to identify these types of conditions and/or retrieve historical reporting on the subject. Once again, the amount and type of information being published can be actively controlled by the initiator, caretaker or legal guardian.

### Please Insert FIG. 6 Here

### Proprietary Client-Facing Zap City Elopement Alert Form© User's Template

### Reference Diagram—FIG. 7

FIG. 7 depicts the proprietary Zap City Elopement Alert Form© user's template including name #, address #, social media alerts/emails #, historical tracking segments #, remaining information and numbers, etc. Once the user downloads the proprietary Zap City Missing Person Alert software application from either Google Play or the Apple Store, they are advised to access the Zap City business website to complete the formal registration process. Once the user downloads the proprietary Zap City Missing Person mobile application and accesses the www.zap-city.com business website, they can also access the proprietary Zap City Elopement Alert Form to create their initial registration content. This proprietary form holds an official copyright from the USPTO (Registration Number TXu-1-868-795/May 17, 2013) and has been attached to the initial provisional filing as FIG. 7.

### Please Insert FIG. 7 Here

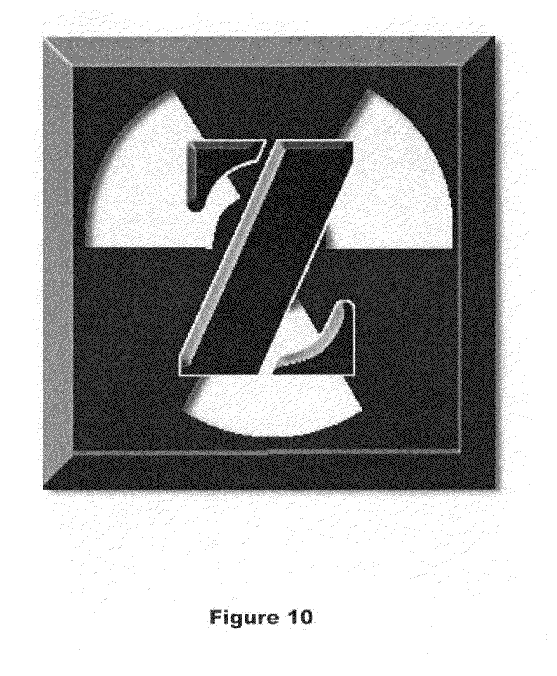

As depicted on the attached FIG. 7 file, the proprietarily developed Zap City Elopement Alert Form© is utilized by the user to initially register family members and/or friends by adding any/all required information to the integrated spreadsheet as follows:
Box 100: “ZAP CITY ELOPEMENT ALERT FORM©” (Title/Header)
Box 110: “Personal Identification/Information and First Responders” (Title)
Box 120: FIG. 8; Zap City Primary Icon/Logo
Box 130: FIG. 10; Zap City Primary Alert Icon/Logo
Box 140: Account Information” Heading
Box 150: “Username” (Integrated Free-Form Text Box for Username Registration Process)
Box 160: “Password” (Integrated Free-Form Text Box for Password Registration Process)
Box 1: “Individual's Name” (heading);
Area 10 (a): includes free-form text area for registering person's “First” name;
Area 10 (b): includes free-form text area for registering person's middle “M.I.” name;
Area 10 (c): includes free-form text area for registering person's “Last” name;
Area 10 (d): includes free-form text area for registering current “Date”;
Area 11: “Attach Current Photo Here:” (Insert Location for Adding Photo);
Box 2: “Address” (heading);
Area 20: includes free-form text area for adding “Street” Address;
Area 21: includes free-form text area for adding name of City;
Area 22: includes dot.net drop-down, with applicable US States listing, to “Select State”;
Area 23: includes free-form text area for adding relevant “Zip” Code;
Box 3: “Date of Birth” (heading);
Area 30 (located directly to the right of Box 3: “Date of Birth” heading): includes an integrated drop-down calendar for adding “Date of Birth”;
Box 4: “Age” (heading);
Area 40 (located directly to the right of Box 4: “Age” heading): includes free-form text area for adding “Age”;
Box 5: “Preferred Name” (heading);
Area 50 (located directly to the right of Box 5: Preferred Name” heading): includes free-form text area for adding “Preferred Name”;
Box 6: EMERGENCY MESSAGING INFORMATION (Heading Scrolls Into Box or Flashes);
Area 60 (a): located directly under the “Email Address” heading, includes free-form text area for adding/registering valid email so the user can receive formal notification from Zap City Alert System;
Area 60 (b): located directly under the “Mobile Number (10 Digits/No Space)” heading, includes free-form text area for adding telephone number. This number is also utilized by the registered user to authenticate and/or sing-in to the Zap City Alert System along with the registered username and password;
Area 60 (c): located directly under the “Voice Broadcasting” heading, includes an area where the registered user can add voice messaging to the emergency alert form for future correspondence, identification purposes, or information usage;
Area 60 (d): located directly under the “Video Mail” heading, includes an area where the registered user can add steaming video content and/or voice messaging to the emergency alert form for future correspondence, identification purposes, or information usage;
Box 7: Not Assigned at this time;
Box 8: “Individual's Physical Description” (heading)
Box 9: “Male/Female” (heading);
Box 10: “Height” (heading);
Box 11: “Weight” (headings);
Box 12: “Eye Color” (heading);
Box 13: “Hair Color”;
Area 90: Drop-Down listing w/“Male or Female” Select Option;
Area 100: Drop-Down listing w/various average height listings, separated by feet/inches, scale lists 1-inch increments starting with a statement of “less than 3′, and subsequently continues upward using 1-inch increments beginning with 3′-1′ through 7′-6”, and finally lists the statement of “more than 7′6” listing as the last entry;
Area 110: Drop-Down listing w/various average weight listing; scale lists 5 pound increments beginning with 30 lbs, 35 lbs, 40 lbs, and continues to increase the selection list in 5 pound increments through 350 lbs, the final option/selection of “350+ lbs.” is the last selection in the drop-down category;
Area 120: Drop-Down listing w/various eye color listing; specific eye color listings/selections include “black, brown, blue, green, and hazel (grey)”;
Area 130: Drop-Down listing w/various hair color listing; hair color listings/selections include “black, brown, blonde, red, and auburn”;
Box 14: “Scars or other identifying Marks (Tattoos, Piercings, etc.)” (heading);
Box 15: “Tattoo(s)” (sub-heading);
Area 150: Drop-Down listing w/“Yes or No” Option;
Box 16: “Piercing(s)” (heading);
Area 160: Drop-Down listing w/“Yes or No” Option;
Box 17: “Scar(s)” (heading);
Box 170: Drop-Down listing w/“Yes or No” Option;
Box 18: “Location” (heading), located directly under “Tattoo(s) heading;
Area 180: Drop-Down listing, located directly under the “Location” (Tattoo(s)) heading, w/various body locations (e.g. right arm, left arm, right leg, left leg, back, shoulder neck). NOTE: Area 180 listing(s) are specific to Box 18 Tattoo(s) placement. Specific tattoo locations/selections (as listed in the drop-down section) include Back (Upper-Left), Back (Upper-Right), Back (Lower-Back), Back (Beltline), Chest (Left-Breast), Chest (Right-Breast), Ears (Left), Ears (Right), Face (Cheek), Face (Eyelids), Face (Forehead), Face (Inner-Lip), Hips (Left), Hips (Right), Left Arm (Shoulder), Left Arm (Bicept/Tricept), Left Arm (Forearm), Left Arm (Wrist), Left Hand (Top), Left Hand (Palm), Left Hand (Fingers), Left Leg (Thigh), Left Leg (Calve), Left Leg (Ankle), Left Foot (Top), Left Foot (Toes), Neck (Back), Neck (Front), Neck (Left), Neck (Right), Rib Cage (Left), Rib Cage (Right), Right Arm (Shoulder), Right Arm (Bicept/Tricept), Right Arm (Forearm), Right Arm (Wrist), Right Hand (Top), Right Hand (Palm), Right Hand (Fingers), Right Leg (Thigh), Right Leg (Calve), Right Leg (Ankle), Right Foot (Top), Right Foot (Toes), Stomache;
Box 19: “Location” (heading), located directly under Piercing(s) heading;
Area 190: Drop-Down listing, located directly under “Locations” (Piercing) heading, w/various body locations (i.e. right arm, left arm, right leg, left leg, back, shoulder neck, etc.). NOTE: Area 190 listing(s) are specific to Box 19 Piercing(s) placement. Specific piercing selections (as listed in the drop-down section) include Chest (Left-Breast), Chest (Right-Breast), Ears (Left), Ears (Right), Face (Left Cheek), Face (Right Cheek), Face (Eyelids), Face (Inner-Lip), Face (Nose), Face (Eyebrows), Head (Forehead), Head (Upper-Lip), Head (Lower-Lip), Head (Tongue), Neck (Back), Neck (Front), Neck (Left), Neck (Right), Stomache (Belly Button);
Box 20: Location (heading), located directly under the Scar(s) heading;
Area 200: Drop-Down listing, located directly under the “Location (Scar(s)) heading, w/various body locations (i.e. right arm, left arm, right leg, left leg, back, shoulder neck, etc.). NOTE: Area 200 listing(s) are specific to Box 20 Scar(s) placement. Specific scar locations/selections (as listed in the drop-down section) include Back (Upper-Left), Back (Upper-Right), Back (Lower-Back), Back (Beltline), Chest (Left-Breast), Chest (Right-Breast), Ears (Left), Ears (Right), Face (Left Cheek), Face (Right Cheek), Face (Eyelids), Face (Forehead), Face (Inner-Lip), Hips (Left), Hips (Right), Left Arm (Shoulder), Left Arm (Bicept/Tricept), Left Arm (Forearm), Left Arm (Wrist), Left Hand (Top), Left Hand (Palm), Left Hand (Fingers), Left Leg (Thigh), Left Leg (Calve), Left Leg (Ankle), Left Foot (Top), Left Foot (Toes), Neck (Back), Neck (Front), Neck (Left), Neck (Right), Rib Cage (Left), Rib Cage (Right), Right Arm (Shoulder), Right Arm (Bicept/Tricept), Right Arm (Forearm), Right Arm (Wrist), Right Hand (Top), Right Hand (Palm), Right Hand (Fingers), Right Leg (Thigh), Right Leg (Calve), Right Leg (Ankle), Right Foot (Top), Right Foot (Toes), Stomache;
Box 21: Free-Form text “Comments”: (heading);
Area 210: User inserts free-form text comments relating to identifying marks categories (e.g. tattoos, piercings, scars);
Area 211: “Add Current Photo Here Showing Identifying Marks” heading;
Area 212: “Add Current Photo Here Showing Identifying Marks” heading;
Box 22: “Other Relevant Medical Conditions” (header);
Box 23: “No Sense of Danger” (header);
Area 230: located directly under the “No Sense of Danger” heading, an “X” is placed in the area 230 when clicked (by mouse) or touched if the person has No Sense of Danger;
Box 24: “Blind” (header);
Area 240: located directly under the “Blind” header, an “X” is placed in the area 240 when clicked (by mouse) or touched if the person is Blind;
Box 25: “Deaf” (header);
Area 250: located directly under the “Deaf” heading, an “X” is placed in the area 250 when clicked (by mouse) or touched if the person is Deaf;
Box 26: “Non-Verbal” (header);
Area 260: located directly under the Non Verbal” heading, an “X” is placed in the area 260 when clicked (by mouse) or touched if the person is Non Verbal;
Box 27: “Prone to Seizures” (header);
Area 270: located directly under the Prone to Seizures” heading, an “X” is placed in the area 270 when clicked (by mouse) or touched if the person is Prone to Seizures;
Box 28: “Other Cognitive Impairment” (header);
Area 280: located directly under the “Other Cognitive Impairment” heading, Drop-Down listing w/“Yes or No” Option;
Area 281: located directly to the right of the Yes/No “Other Cognitive Impairment” header, a

Drop-Down listing w/Cognitive Disorder/Impairment Selection Listing, impairment listings/selections are listed as Additictions (Alcohol/Drugs), Alzheimers, Amnesia, Attention Deficit, Autism, Bipolar, Delirium, Dementia, Depression, Manic/Mania, Mental Retardation, and Psychotic is created for the user to select once the YES option under the “Other Cognitive Impairment” box is selected;
Box 29: “Emergency Contact Information” (header);
Box 30: “Contact Name” (header);
Area 300: located directly under the “Contact Name” heading, Free-Form Box for entering

Contact Name;
Box 31: “Contact w/Address and/or Email” (header);
Area 310: located directly under the “Contact w/Address and/or Email” heading, Free-Form Text Box for entering Contact Address and/or Email;
Box 32: “Home Phone Number” (header);
Area 320: located directly to the right of the “Home Phone Number” Box, Free-Form Text Box for entering Home Telephone Number and Active Dial-Out Link;
Box 33: “Work Phone Number” (header);
Area 330: located directly to the right of the “Work Phone Number” Box, Free-Form Text

Box for Entering Work Telephone Number and Active Dial-Out Link;
Box 34: “Cell Phone Number” (header);
Area 340: located directly to the right of the “Cell Phone Number” Box, Free-Form Text Box for entering Cellular Telephone Number and Active Dial-Out Link;
Box 35: “Contact Name Alternate” (header);
Area 350: located directly below the “Contact Name (Alternate)” Box, Free-Form Text Box for entering Alternate Contact name;
Box 36: “Contact Address Alternate” (header);
Area 360: located directly below the “Contact E-Mail Address (Alternate)” heading, Free-Form Text Box for entering Alternate Contact Address and/or Email;
Box 40: Proprietary “Zap City Mapping Grid” (header);
Area 400: The proprietary mapping grid will allow the user to (a) select the default address from Area(s) 21, 22, 23 & 24 as the primary location, or (b) use/select the mobile devices GPS coordinates to establish the initial starting point on the map. When the proprietary Zap City Elopement Alert Form (C) is opened by the mobile device (prior to publishing a formal search notification), the integrated software solution will ask the user if they prefer to use the default location in the aforementioned Area(s), or select the current location via GPS. Once the initial location has been identified by the user, the mapping grid shown in Box 40 will use open-source API mapping components to populate the mapping grid. If the user selected the default location, the open-source mapping grid will also include an additional mapping overlay that depicts the proprietary mapping grid as depicted and defined in FIGS. 1 and 2, and will include any/all embedded icons that were previously selected by the user as depicted and defined in FIG. 3. If the current GPS coordinates are selected as the initial location, the same information will populate once the user has enabled the area-wide mapping component.
Box 41: “Historical Tracking Log” (header);
Area 410: This area will allow the any/all users to monitor both uni-lateral and bi-lateral communications from authorized/active search participants. Once the Zap City Elopement Alert Form© is opened on a mobile device or computer, and an official search notification is published by the user, any/all information regarding the current search efforts are posting in chronological order by any/all authorized search members. Thus, allowing each authorized member to track the search efforts in real-time. Once the missing subject is located, a statement can be posted through the Historical Tracking Form that will notify any/all search parties of the results. In addition, the software application will allow the primary user (the user who authorized/published the initial search notification) that the official search has ended.

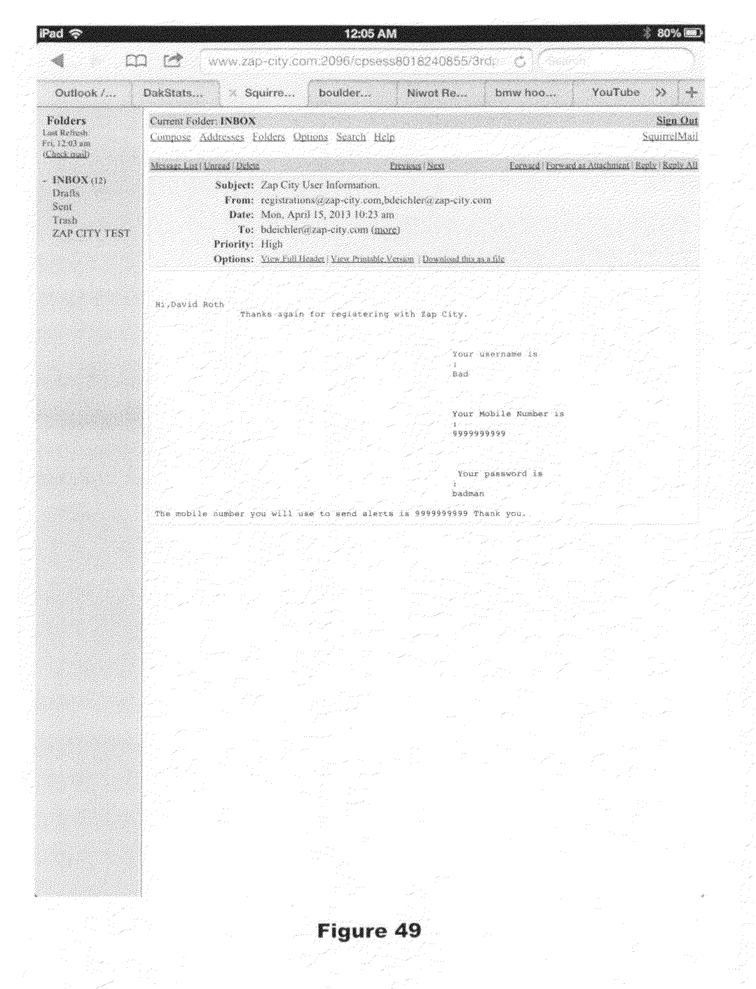

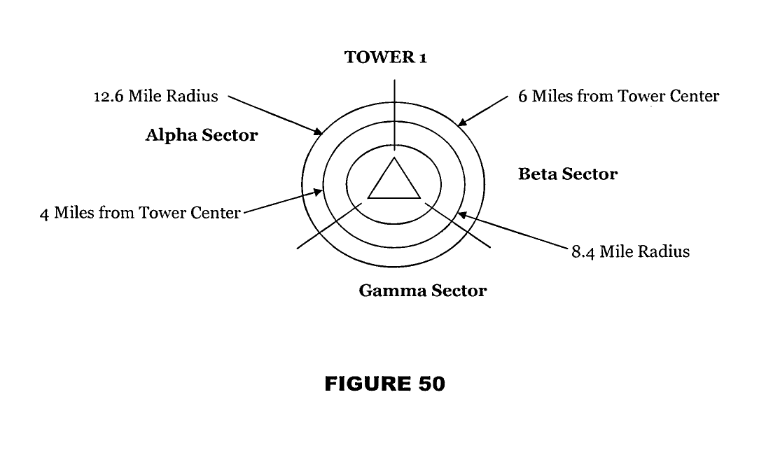

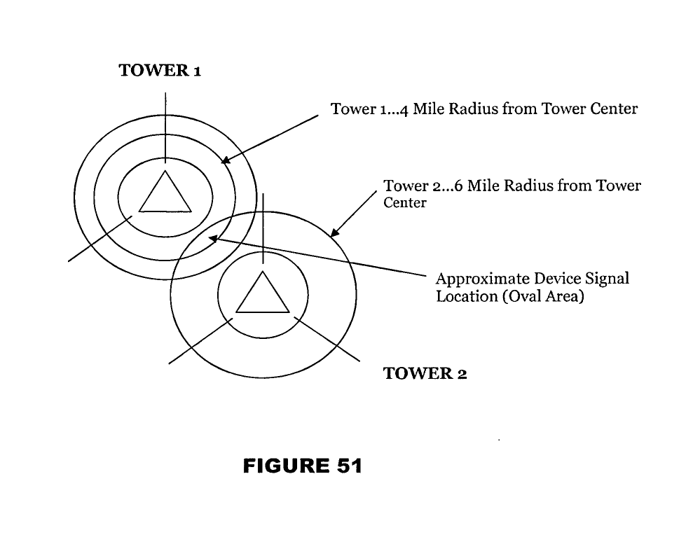

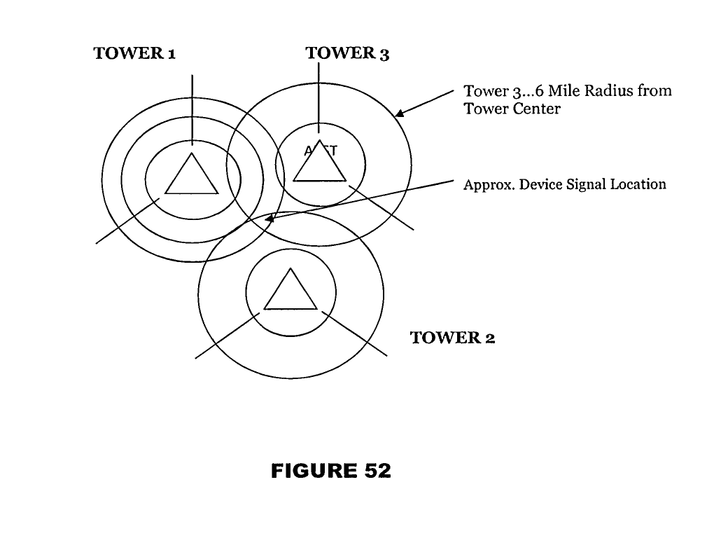

Once the user has registered any/all family members, or friends, using the Zap City Elopement Alert Form©, they will receive an initial email notification verifying receipt of the formal registration process and registered content. An example of the initial registration email notification has been included as part of the initial provisional application filing with the USPTO and is filed as FIG. 49.

### Please Insert FIG. 49 Here

Once the registered user officially files/registers their initial username, password, and telephone number using the proprietary Elopement Alert Form, they will receive the following information:
To add another family member, click [CONTINUE]. To complete registration, click ok. http://zap-city.com
   Thank you for registering with Zap City. Please look for confirmation email with important information about your Zap City account. If you do not see email, please check your SPAM folder.

At this time, the registered user can utilize the proprietary Zap City Elopement Alert Form to add/change as many family members, or friends, to their personal database as required. By utilizing the Elopement Alert Form to add additional members the registered user will be able to access any/all family/friends who have been added to the database, and as a result, use the proprietary software to access the information for any/all individuals during the time of an emergency.

### Primary Icon Used to Connect User and/or Personal Computing Devices, Mobile Peripheral Devices, and Mobile Software Applications to the Organization's Business Website Via the Proprietary User Interface

### Reference Diagram—FIG. 8

FIG. 8 depicts the Zap City Primary Business Icon© 1 that when selected or depressed by the user, will provide the user with the ability to go to (a) the businesses primary host website, or, (b) will allow the user to review any/all application software after being directed to the businesses primary landing page when using a mobile peripheral, wireless device, or computer.

By selecting, clicking, touching or depressing the primary tile/icon 1 the user will be presented with a series of tiles/icons after arriving at the mobile landing page that represent the proprietary software solutions and allows them the option to: go to/utilize/deploy the primary Zap City Missing Person Alert© communication and mapping software component as depicted and defined in FIGS. 1, 2, 9 & 20, and use the proprietary application to open and utilize the software as a personal location and tracking component as depicted and defined in the background, brief summary, detailed description, drawings, claims and abstract sections for this invention, or in the proprietary application software that will allow the user to open and utilize the proprietary mapping component as depicted and defined in FIGS. 1 & 2.

This symbol is projected to become the formal trademark, or brand icon, of the organization and an official Trademark application has already been officially filed with the USPTO for formal review, prosecution, and registration.

### Please Insert FIG. 8 Here

### Proprietary Mapping Grid w/Bio Sensor Identification Password

### Reference Diagram—FIG. 9 (Zap Map Mobile Tile/Icon)

FIG. 9 depicts the proprietary mapping grid icon/mobile tile that is integrated with various open-source API mapping components as depicted and defined in FIGS. 1 & 2 to create/establish the central point-of-location for the user to utilize as either their primary (default) address, as depicted and defined in FIG. 7 on the Proprietary Elopement Alert Form© users template, or to activate the mobile peripherals (mobile devices) automated GPS coordinate identification/tracking system to use as the initial point-of location prior to the user creating or establishing a formal search notification. The integrated mapping solution utilizes existing biometric sensors (e.g. fingerprint analyzing software) as a security component that authenticates the user's initial request and grants access to both the telephone and the proprietary software application(s) as depicted and defined herein, and allows the user to certify, register or identify themselves prior to usage as a means to authenticate and/or validate their authority for assignment and their relative position upon the functional mapping grid.

As developed, the mobile application tile/icon will allow the user to connect to the businesses host website, or, allow the user to open the proprietary mapping component to identify their relative location and/or update (add/delete/change) any of the personal information on the mapping grid that was previously stored by the user when using the proprietary Zap City Elopement Alert Form 0 template as described in FIG. 7.

FIG. 9, Box 2 represents the letter Z, Box 3 represents the letter A, Box 4 represents the letter P, Box 5 represents the letter M, Box 6 represents the letter P, Box 7 will represent an arrow pointing in a northwest direction, Box 8 represents an arrow pointing in a northeast direction, Box 9 represents an arrow pointing in a southwest direction, and Box 10 represents an arrow pointing in a southeast direction.

### Please Insert FIG. 9 Here

### Proprietary Mobile ALERT Application w/Integrated Mapping Solution

### Reference Diagram—FIG. 10

FIG. 10 depicts the proprietary Zap City Emergency Alert Icon© that is utilized to actively integrate the proprietary Mobile ALERT search and location application as depicted and defined herein in FIG. 10, with the proprietary mapping grid/utility application(s) as depicted and defined in FIGS. 2, 3, 4, 5, 6, 7, and 9. To initiate a formal search request, the user would engage (select) the proprietary ALERT icon. Once selected, the application Icon will allow the user to open the proprietary Zap City Elopement Alert Form© template as depicted and defined in FIG. 7, and update any relevant information prior to publishing a formal search request. The application will allow the user to utilize/select the default address as listed in Area(s) A20, A21, A22 and A23 on the Elopement Alert Form, or, use the current GPS coordinates to establish the initial point of location on the device.

Once the primary/initial location of the device is selected (via GPS) by the user the application will use the mapping grid to create/store an initial geographic location and retain the coordinates in a pre-assigned database profile until the user is ready to deploy the proprietarily integrated utility solutions as depicted and defined in the aforementioned applications and figures. These applications will coincide with the warning icons listed in FIG. 3, and various open-source mapping components to create a formal grid that will be utilized by the authorized users during the search. The proprietary Zap City Elopement Alert Form© will also accompany any/all communications during the initial search notification, and therefore, will be viewed/utilized as the primary resource information to any/all authorized recipients who are assisting with the formal search.

For example, but not limited to, if an official search is published by an authenticated user and an integrated mapping grid is established (as depicted and defined in FIGS. 2, 3 and 9) showing 4 mapping sectors (A, B, C & D), plus any/all proprietary warning symbols (hot spots, danger zones) as depicted and defined in FIG. 3, the system will initially capture and utilize the GPS coordinates of any/all professional/emergency search personnel who fall within the pre-defined grid (search) area and have authenticated their official authority and/or signed-in to the official search, plus, any authorized non-emergency personnel (e.g. friends, family, social network). Once these parameters are defined, and the assigned/authorized personnel are located and automatically notified by the system, the proprietary software application/business model will initiate a process to: (a) identify which emergency responder is closest to each of the preliminarily defined most-probable elopement locations (based upon historical data modeling and the probability ratios developed by the software elements defined in FIGS. 2 & 3), (b) create both a straight line vector (as the crow flies) from the closest emergency responder to each of the predefined locations on the historical mapping grid, and secondarily, create a customized—directional street map depicting actual streets etc., and in response, will examine the difference in distance to these preferred locations prior to projecting a response time for each location when compared to the authorized search participants and their relative locations at the time of assignment.

The integrated software applications will utilize the mathematical models, as previously described, to send automated messages to each of the emergency responders requesting their ability/consent to search these proprietarily assigned locations. If any of the emergency responders declines an automated sign-in request, or declines a specific location search request, the integrated model re-examines the remaining personnel that fall within the current grid parameters and creates a new automated roster to successfully repeat the location inquiries based upon the emergency responders relative locations.

Also, Area 60, as depicted and defined on FIG. 7, will allow the user to either; (a) select a pre-defined, actively stored automated message, or (b) create a specific custom message, using free-form text, to include with the published communications and/or elopement information. It should also be noted that the user can include any/all audio, video or photo content along with these automated communication processes. Once the user defines the communication content listed within Area 60 on FIG. 7, the user can select the preferred or predefined recipients who are authorized to receive the private communication content. The recipients can range from Police & Fire emergency personnel, friends, family members, and social network contacts, and will be identified/selected by either; (a) the user selecting the contact references found in Area(s) 71, 72 and 73 on the Zap City Elopement Alert Form© (as depicted in FIG. 7), or, by the user adding a specific email address, telephone number (e.g. 9-1-1), or any other content that can be transmitted during these communications. These areas, as previously defined in this paragraph, have been actively integrated with; (a) the proprietary Zap City Elopement Alert Form©, (b) the specific mobile peripheral device, and (c) the individual social networks through the use of an open API infrastructure.

For example, but not limited to, if an email address is selected, the authorized recipient will receive an email message containing the proprietary information from Area 60 as defined above. If the social media networks are selected, the recipient will also receive the proprietary information through these social mediums (e.g. Live Tweets, Facebook Wall Postings), and, the content will include any/all information contained within the Zap City Elopement Alert Form©, plus any addition information communicated by the user prior to official distribution. As with the other items in the software suite, the Historical Tracking Log will be updated anytime an authorized user sends an update to the primary user who initiated the official search. The authorized users will also receive real-time updates from the Historical Tracking Log and any/all information pertaining to the finalized search notice once the event has officially been closed by the initiator.

Any/All information communicated during these processes will be added as a real-time update to the Historical Tracking Log as depicted and defined in FIG. 7, Area 410, and will utilize both unilateral and bilateral communication resources to publish the communication content to all authenticated search participants/recipients. Also, the Emergency Contact Information listed in Area(s) 300, 310, 320, 330, 340, 350, 360, 370, 380, and 390 on the proprietary Zap City Elopement Form© (as depicted in FIG. 7), will receive the proprietary search notification, private information and real-time updates from the Historical Tracking Log. Audio and Video content, as well as photographs, will be included as part of these emergency and non-emergency communications.

### Please Insert FIG. 10 Here

### Zap City Website, Mobile App & Database Architecture Business Concept, Process Workflow & Active Integration Model

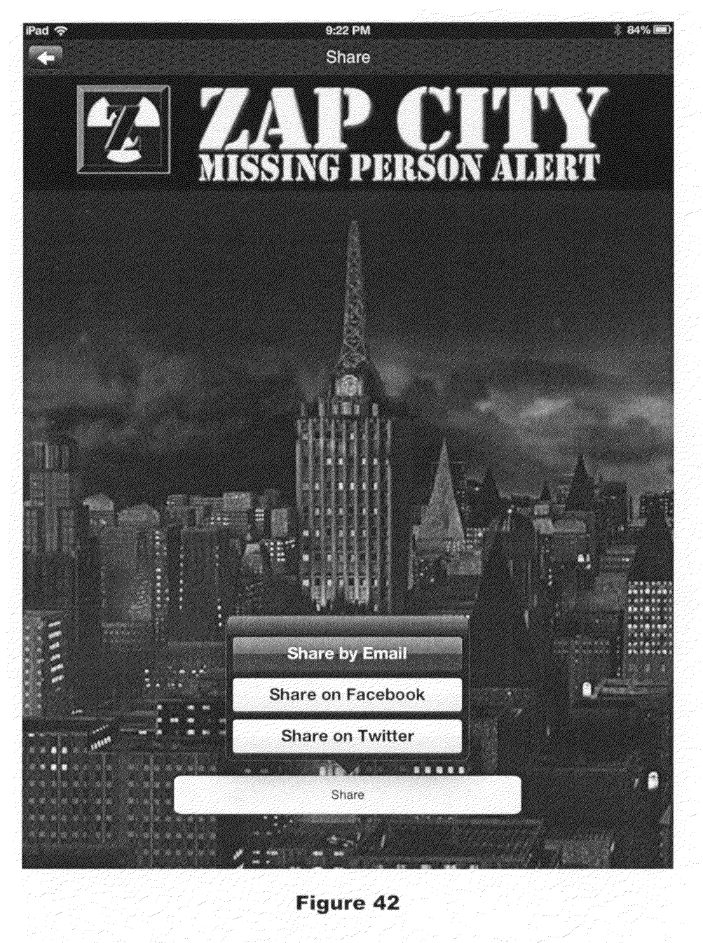

1. The Consumer visits the www.zap-city.com website.
2. After the user accesses the www.zap-city.com website, they will use/click an active link that will allow the user to access the proprietary Zap City Elopement Alert Form©, as depicted in FIG. 7.
3. Once the user has accessed the Zap City Elopement Alert Form© they can utilize the proprietarily developed form to register any/all preferred persons/family members into the Relational Database that feeds both the website and the mobile application software.
4. If the Consumer (User) has established social media accounts (e.g. Facebook, Twitter, Email Lists), they can be accessed by the Zap City Mobile Application, as shown in FIG. 42. Once the user authorizes a formal search notification via the mobile app, the Social Media accounts can also be selected to receive the same emergency alert notifications simultaneously along with the email and proprietary mapping alerts.
5. Zap City's Mobile App is used to send formal alerts to consumers who have downloaded the Mobile App via iTunes or Google Play Stores, and who have actively registered their contact information on the Zap City business website using the proprietary Zap City Elopement Alert Form© as depicted in FIG. 7.
6. The Consumer also has the ability to edit the website registration form to ensure accurate information in a real-time format.
7. The www.zap-city.com website and Mobile Apps shares the same Relational Database to ensure that the data is always 100% in synch by using a bi-lateral communication protocol.
8. The proprietary Zap City Mapping Grid feature allows the user to select a predetermined radius that covers a 1, 2, 3, 5, 10, 20 and 50 mile radius from the address where the formal search was initiated.
9. The proprietary Zap City Elopement Alert Form© includes a complete biographical profile on the registered person, including general information (e.g. name, address, telephone), as well as categories describing the individual's physical description (e.g. height, weight, eye/hair color, tattoos, piercings, scars). The Zap City Elopement Alert Form also contains emergency contact information (e.g. name, address, telephone number(s), email addresses). The Zap City Elopement Alert Form© also contains areas where photographs, voice messages, and live streaming video content can be added and/or delivered. This information is emailed to any/all selected persons who have registered at the www.zap-city.com website and downloaded the Mobile App.
10. Zap City administrator(s) also have the capability of sending “mass notifications” to everyone that has downloaded the Mobile App.

### Design, Code Development and Architectural Works

The architectural works/development code will be identified herein and submitted to the United States Patent and Trademark Office (USPTO) in both Provisional and Non-Provisional formats to protect any/all Copyright's, concepts, designs, process workflow and proprietary code development. The concept was described in detail earlier in this document.

### Design

The Zap City website, database and Mobile App are designed to send immediate “alerts” when a person goes missing via email and native Mobile App notifications. The primary objective is to reduce the amount of time it takes to successfully locate a missing person by way of improved and/or advanced communications and probability ratios, thereby improving the chance to save a life.

### Code Development

The website, database and Mobile app are built using the latest PHP, IOS 6, Ajax, HTML5, JSON and MySQL database technologies. With the exception of Zap City's proprietary development code, the technology being utilized is Open Source. Therefore, outside of the proprietarily developed code/script, the architectural works, how the proprietarily coded technologies communicate and/or exchange information, and the unique process workflow are the basis of our patent and copyright submissions.

PHP is an open source, general-purpose, server-side scripting language originally designed for Web development to produce dynamic Web pages. It is one of the first developed server-side scripting languages to be embedded into an HTML source document rather than calling an external file to process data. The code is interpreted by a Web server with a PHP processor module which generates the resulting Web page. It has also evolved to include a command-line interface capability and can be used in standalone graphical applications. PHP can be deployed on most Web servers and also as a standalone shell on almost every operating system and platform, free of charge. A competitor to Microsoft's Active Server Pages (ASP) server-side script engine and similar languages, PHP is installed on more than 20 million Web sites and 1 million Web servers. Software that uses PHP includes Drupal, Joomla, MediaWiki, and WordPress.

Ajax, also known as AJAX, is an acronym for Asynchronous JavaScript and XML. Ajax is a group of interrelated web development techniques used on the client-side to create asynchronous web applications. With Ajax, web applications can send data to, and retrieve data from, a server asynchronously (in the background) without interfering with the display and behavior of the existing page. Data can be retrieved using the XMLHttpRequest object. Despite the name, the use of XML is not required (JSON is often used instead), and the requests do not need to be asynchronous.

Ajax is not a single technology, but a group of technologies. HTML and CSS can be used in combination to mark up and style information. The DOM is accessed with JavaScript to dynamically display, and to allow the user to interact with the information presented. JavaScript and the XMLHttpRequest object provide a method for exchanging data asynchronously between browser and server to avoid full page reloads.

HTML5 is a markup language used for structuring and presenting content for the World Wide Web and a core technology of the Internet. It is the fifth revision of the HTML standard (created in 1990 and standardized as HTML4 as of 1997), and, as of December 2012, is a W3C Candidate Recommendation. Its core aims have been to improve the language with support for the latest multimedia while keeping it easily readable by humans and consistently understood by computers and devices (e.g. web browsers, parsers). HTML5 is intended to subsume not only HTML 4, but XHTML 1 and DOM Level 2 HTML as well.

MySQL (pronounced: My S-Q-L, officially, but also called “My Sequel”) is the world's most used open source relational database management system (RDBMS) as of 2008 that runs as a server providing multi-user access to a number of databases.

It is named after co-founder Michael Widenius' daughter, My. The SQL phrase stands for Structured Query Language.

The MySQL development project has made its source code available under the terms of the GNU General Public License, as well as under a variety of proprietary agreements. MySQL was owned and sponsored by a single for-profit firm, the Swedish company MySQL AB, now owned by Oracle Corporation.

MySQL is a popular choice of database for use in web applications, and is a central component of the widely used LAMP open source web application software stack (and other ‘AMP’ stacks). LAMP is an acronym for “Linux, Apache, MySQL, Perl/PHP/Python.” Free-software-open source projects that require a full-featured database management system often use MySQL.

iOS 6 brings the retrieval of documents such as boarding passes, admission tickets, coupons and loyalty cards through its new Passbook app. An iOS device with Passbook can be scanned under a reader to process a mobile payment at participating locations. The app has context-aware features such as notifications for relevant coupons when in the immediate vicinity of a given store.

Apple's Siri intelligent personal assistant was improved to include the ability to make restaurant reservations, launch apps, dictate Facebook or Twitter updates, retrieve movie reviews and detailed sports statistics. Siri, which previously was only supported on iPhone 4S, is also now supported on iPhone 5, iPod touch 5th generation, iPad 3rd generation, iPad (4th generation) and iPad Mini.

Facebook comes integrated through Apple's native apps with iOS 6. Facebook features can be directly accessed from within native apps such as Calendar which can sync Facebook events, or use Facebook's like button from within the Apple App Store.^{[4]}

New privacy settings are available to the user. In addition to location services, the following have been added in iOS 6: photos (already partially restricted in iOS 5), contacts (address book), calendars, reminders, bluetooth sharing, Twitter, Facebook, and Sina Weibo. iOS 6 also comes with a “Limit ad tracking” user control in the general settings menu to allow users the option to prevent targeted advertising. Apple's Advertising Identifier replaces the company's existing UDID standard. Advertising networks not yet using Apple's Advertising Identifier device identifier standard would not be affected although Apple will require the standard in the future.

Google Earth Map code is used to produce the Mapping Grid information provided within the website and Mobile App. The Mobile App also has Apple's new vector-based engine that eliminates the lag present while downloading bitmaps from Google's servers, making for smoother zooming. New to Maps is the turn-by-turn navigation and spoken directions functionality in certain countries, 3D views in some major cities and real-time traffic. Turn-by-turn navigation is only available for iPhone 4S or later and iPad 2 or later with cellular capability, while 3D views are only available for iPhone 4S or later, iPod touch 5th generation, and iPad 2 or later.

Social Media Multi Post

Both PHP and Ajax technologies are used to send concurrent posts to registered users with Facebook and Twitter accounts.

iTunes and Google Play

iTunes: We will follow the below process to setup FREE or price based Mobile App in iTunes.

https://developer.apple.com/programs/ios/

iTunes: We will follow the below process to setup price based Mobile App in iTunes.

http://support.google.com/googleplay/android-developer/answer/112622?hl=en
Android: We will follow the below process to setup FREE based Mobile App in Android
http://support.google.com/googleplay/android-developer/answer/113466?hl=en&

### Zap City Architectural Work Flow Diagram

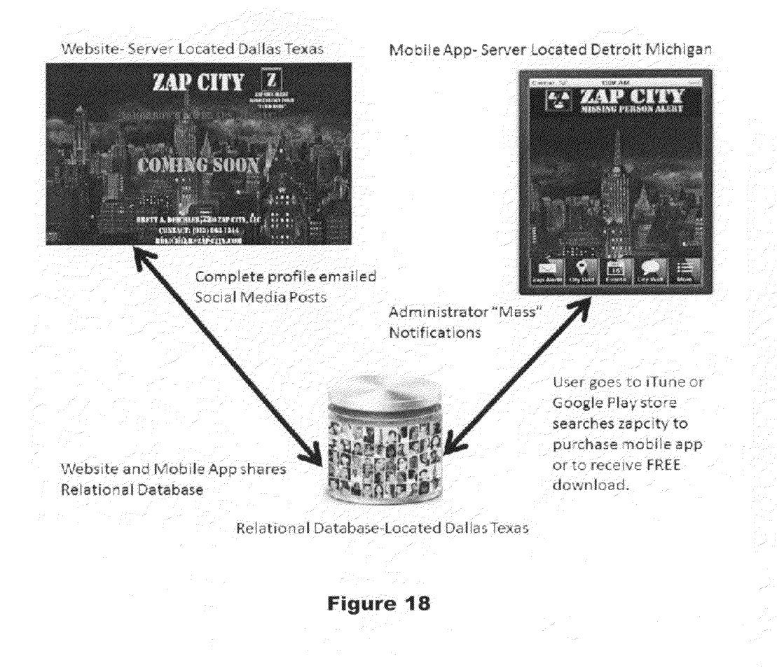

### Please Insert FIG. 18 Here

### Zap City Mobile App Onsite Photo Upload Feature

Zap City Mobile App uses PHP, Apple iOS and Ajax coding to enable an on-site photo upload for Apple iPhone users. This feature will be available for Android users with next release android iOS code.

### Multi Contact Platform

The Zap City Mobile App integrates with a powerful multi contact platform (MCP). Please see below MCP Platform Diagram.
The MCP integrates email, voice broadcast and text messaging, sending all three (3) simultaneously to every registered Zap City system user.
When a Zap City user sends an “alert”, all Zap City users, who have been previously and/or specifically authorized by the sender to receive the proprietary alert notification, will receive an email, text and voice broadcast simultaneously.
When the individual Zap City user selects “Alert” from the Mobile App, they are given a choice to send a prerecorded message (stored in the Elopement Database) or to dial an 800 number to record and send a voice broadcast.
The Zap City system administrator will be able to send Push Notifications to all Zap City system users simultaneously.

### Zap City Multi-Contact Platform

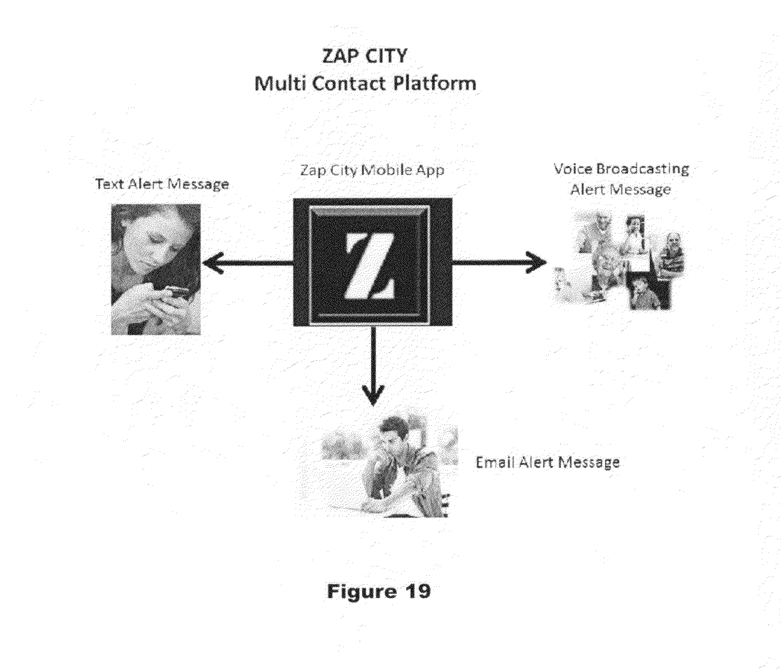

### Please Insert FIG. 19 Here

### Zap City Mobile Application Work Flow Diagram

Zap City's mobile application, as depicted in FIGS. 18 & 19, utilizes a multitude of integrated services to create a dynamic workflow to allow the user to effectively manage any/all relevant data content, and as a result, issue proprietary emergency alert notifications to any/all pre-authorized users.

Once the user has successfully downloaded and opened the Zap City mobile application, they are taken to the mobile website application depicting the following business tabs;

### [Zap Alerts] [City Grid] [Events] [City Wall] [Zap Pics] [More]

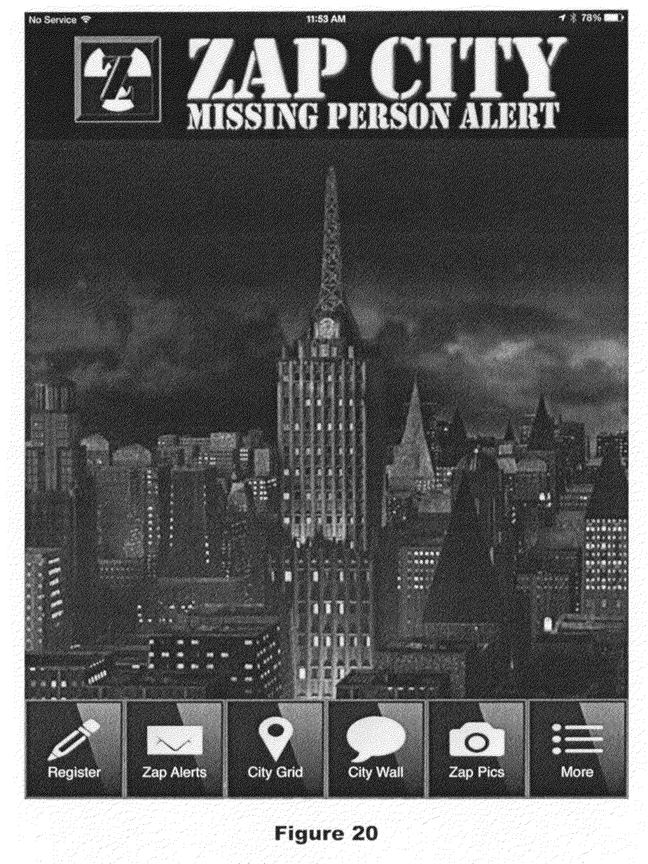

### Please Insert FIG. 20 Here

As initially designed, the Zap Alerts, City Grids, Events, City Wall, Zap Pics and More tabs will allow the user to access applicable business information pertaining to Zap City LLC. These tabs, and their respective functionality, will be explained in greater detail in accordance to the sequential diagram outline:

### Zap City Mobile Alert Application Workflow Diagrams

### General Outline(s), Business Language Narration(s) & Integrated Workflow Diagrams

### General Outline(s):

FIG. 20: Zap City Mobile Application Landing Page, includes business artwork and/or specific business tabs that proprietarily connect the registered user to the desired functions.
FIG. 20; Register Tab; directs the user to the Zap City Elopement Alert Form© which will allow them to initially register with Zap City LLC. Once the individual users are formally registered, they will be able to create/save individual profiles for any/all family member, friends, or other persons, and utilize the private file information, and the proprietary communication software elements as designed by Zap City LLC, to participate and/or send either an emergency or non-emergency alerts.
FIG. 20; Zap Alerts Tab; includes information and/or general workflow methodologies to allow the registered user to create and publish a formal emergency alert notification to any/all pre-registered users.
FIG. 20; City Grids Tab; includes general information and/or provides connectivity for the user to identify a specific geographic location and use the Zap City Mobile Application to create an interactive mapping grid.
FIG. 20; City Wall Tab; includes general information for registered users to read/review regarding the Zap City applications. This is an Apple feature that allows the registered user to also publish information directly to the Zap City Wall for other registered users to review. Once received, the information will be posted to the City Wall in chronological order and be available for users to peruse.
FIG. 20; Zap Pics Tab; allows the user to either, (a) create/take a photo or video and upload the information to the Zap City notification website, or, (b) allows the user to locate and/or utilize an existing photo or video on the specific device to upload the information to the Zap City notification website.
FIG. 20; More Tab; allows the user to share the Zap City mobile application, or their registered data with another user and/or person by social media connection. For example, but not necessarily limited to, Facebook, Twitter, or email/text notifications. The More tab also allows the user to sign-up for Zap City's electronic business mailings (newsletters, etc.), or create a specific mapping grid by entering their current location. Once a specific location is identified, an interactive map is created that depicts a flashing beacon at the specific location.

### Business Language Narration(s)

### Language Narration/Description for Zap Alerts Tab:

As depicted in FIG. 20, if the registered user intends to create/send a formal alert they must first use the Zap Alerts tab to officially sign-in to the proprietary software application. After accessing the Zap Alerts tab the user will be required to sign-in using their official username, password and mobile number to access the software and create/send a formal alert. This general information was created and/or defined at the time of initial registration by the user using the integrated Zap City Elopement Alert Form©.

For example, once the user opens/activates the Zap City mobile application and selects the Zap Alerts tab they will receive a landing screen requesting the following information;
Username
Password
Phone Number
[Sign-In]

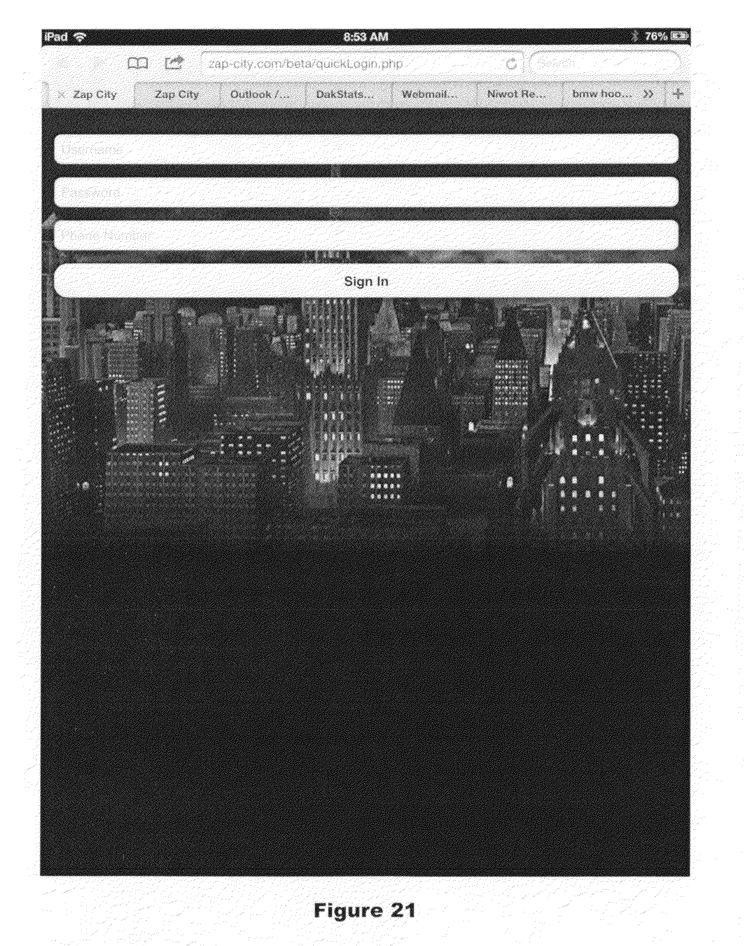

### Please Insert FIG. 21 Here

As depicted in both FIG. 18 and FIG. 20, the Zap Alerts tab is initially utilized to access both the mobile website and the relational database that warehouses the user's pre-established family/friend information from the initial registration. Upon accessing the Zap Alerts tab, and entering the aforementioned information to officially log-in, the user is notified and/or receives the following message;
System Alerts
Social Media Alert
Child Found
The user can click/select the desired heading(s) to access and engage the applicable action(s)

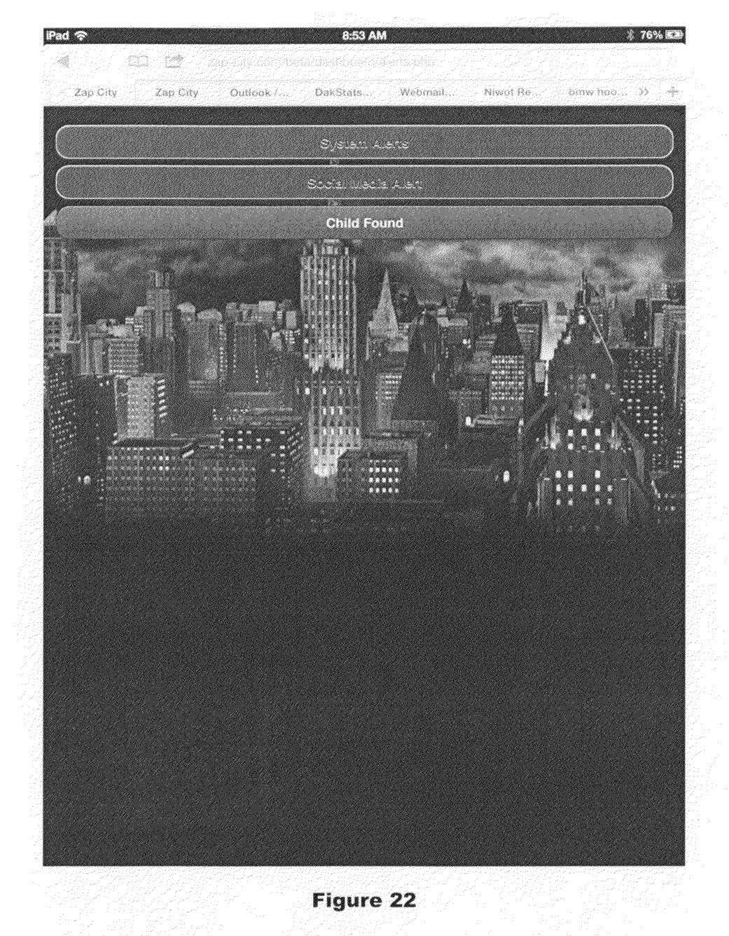

### Please Insert FIG. 22 Here

If the user selects the System Alerts tab, they will be taken to the Send Alert notification page, or, if the user selects the Social Media Alert tab they will be taken to the Social Media Alert landing page as described later herein, or, if the user selects the Child Found tab they will be taken to the Child Found landing page as described later herein.

For example; if the user selects the System Alerts tab they are taken to the following screen that reads;
Send Alert
You are sending this alert to all the system users that your child is missing. To proceed click
“Continue” otherwise click “Cancel”.
[Continue]
[Cancel]

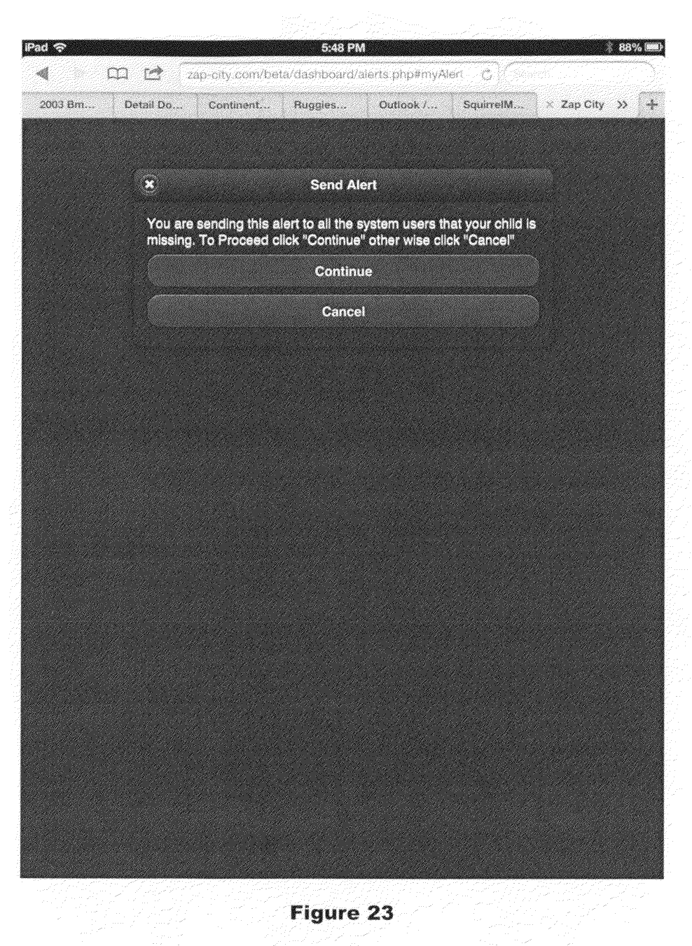

### Please Insert FIG. 23 Here

If the user selects Continue, they are taken to the following screen that reads;
Select the Child
Select the person you want to send alert out for.
(A drop-down arrow allows the user to select the appropriate person that was successfully added and/or registered using the Zap City Elopement Alert Form©) (Registered Person-Name 1, Registered Person-Name 2, etc. will be displayed in the official drop-down section)
[Continue]

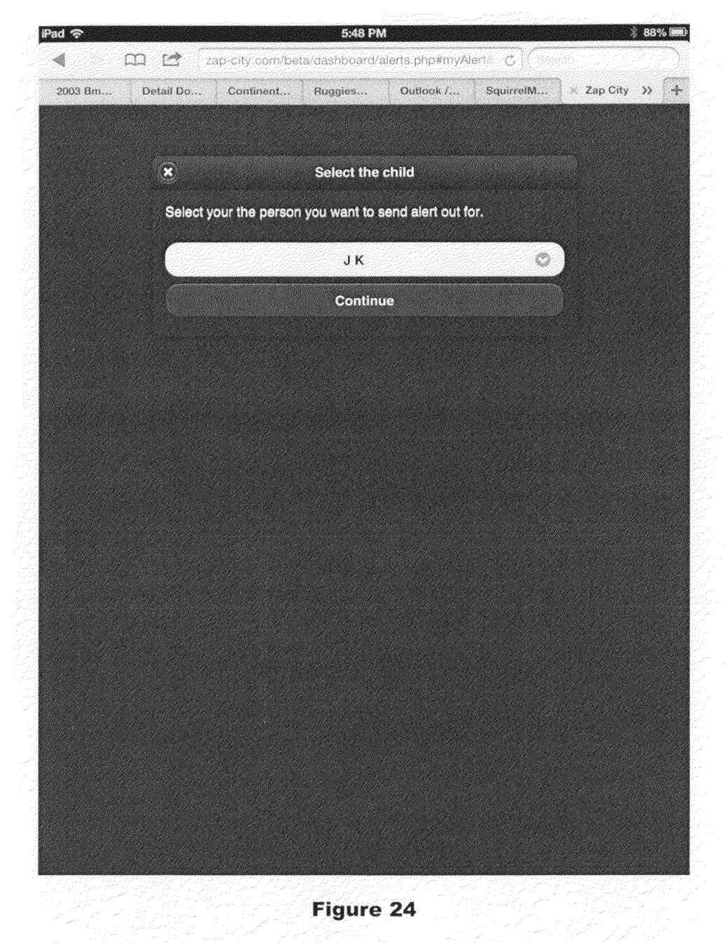

### Please Insert FIG. 24 Here

Once the user lands on the Select the Child page, a drop-down box will be presented that allows them to select one of the pre-registered family/friends as the primary missing person for the formal alert. Once one of the family members and/or friends are selected, and the user selects the Continue tab, the relational database will also select (access) the proprietary information as previously registered for the selected family/friend and prepare the information for emergency transfer to the selected registrants.

If the user selects the Continue tab, they are taken to the following screen that reads;
Update Profile Info?
Do you need to update your current profile info for the lost individual?
[Yes]
[No]

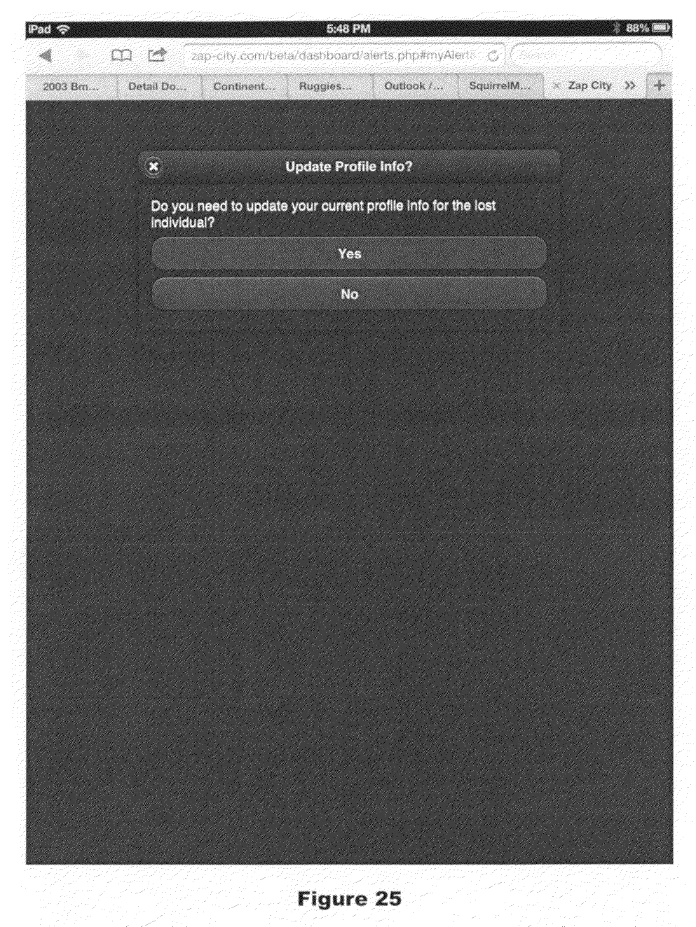

### Please Insert FIG. 25 Here

If the user selects YES, they are taken to a screen that allows them to update certain information from their mobile device such as, but not necessarily limited to, height, weight, add personal photographs, or similar demographics. The height and weight categories are based upon either 1-inch increments ranging from 3′-0″ to 7′-0″, or 5 pound increments ranging from 30 pounds to 350 pounds. The photo (static picture) classification allows the user to select either an existing photo from the devices library, or to take a new picture and add it accordingly.
Update Info
The following information can be updated on your mobile device
Height (w/Drop-Down)
Weight (w/Drop-Down)
Photo (Choose File) No Photo Selected
[Continue]

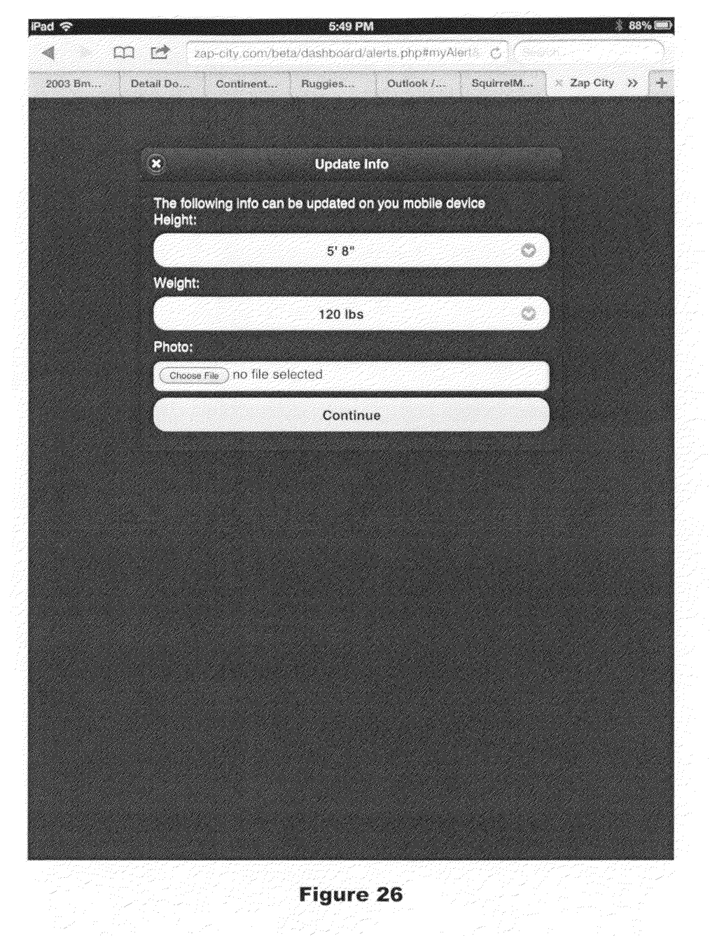

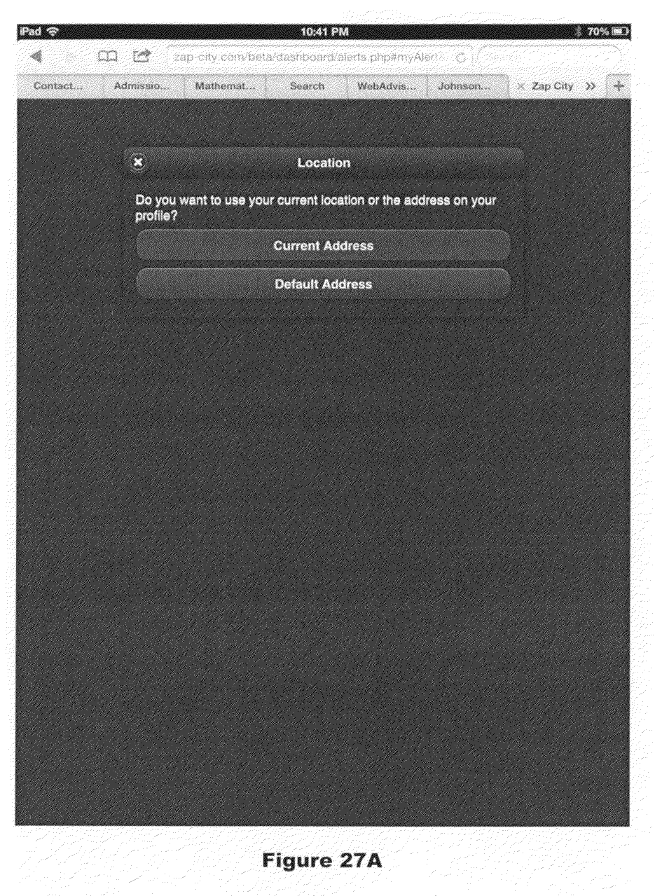

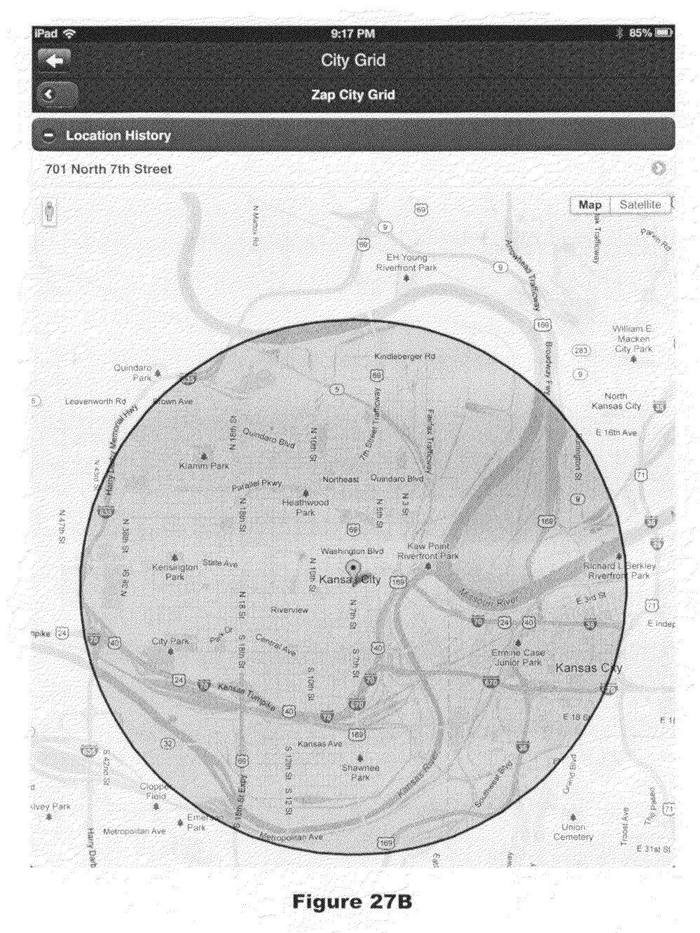

### Please Insert FIG. 26 Here

Once the profile has been updated by the user, the application will take the user to the Location landing page to identify the relevant location and/or point where the missing person was last seen. Also, if the user selects NO on the Update Profile Info page, they are taken to the same Location landing page to identify the relevant location and/or point where the missing person was last seen.

Once the user is taken to the Location page, they will receive the following message;
Location
Do you want to use your current location or the (default) address on your profile?
(Current Address: Added via GPS or Free-Form Text)
(Default Address: Added Using Elopement Alert Form)
(Current/Last Known Location Unknown)

### Please Insert FIG. 27A Here

If the user selects the Current Address, they will receive the following screen message;
Location
Address (Free-Form Text)
City (Free-Form Text)
State (Drop-Down w/Individual States Displayed for Selection)
Zip Code (Free-Form Text)
[Continue]

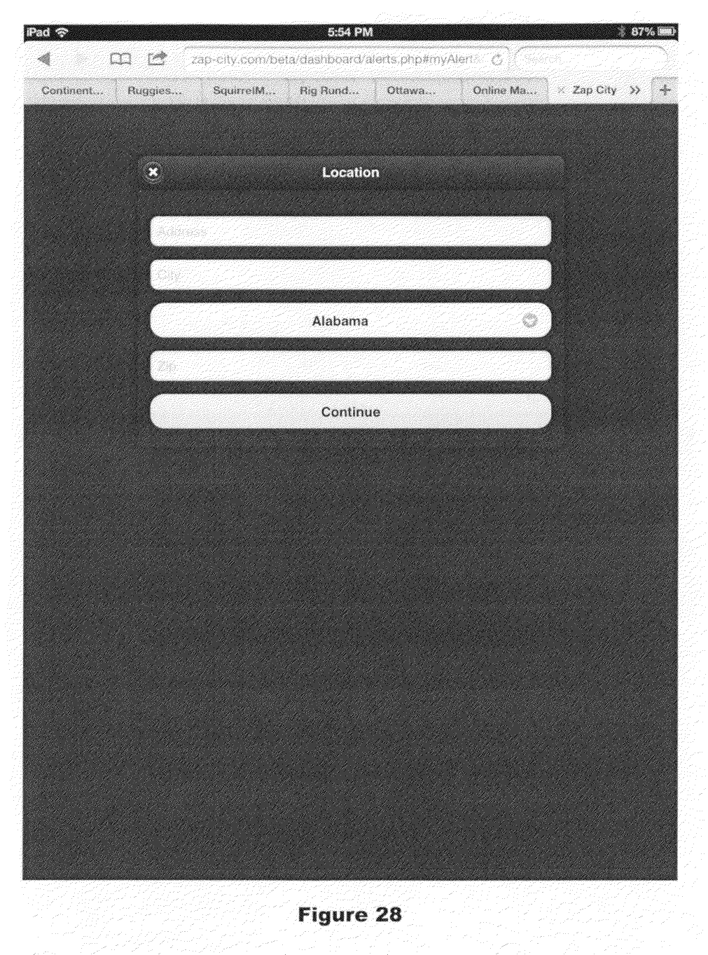

### Please Insert FIG. 28 Here

Once the user enters the current location, a map is generated, and held in queue, until the formal alert is published by the user.

Also, if the user selects Default Address from the menu, the address as originally registered using the Zap City Elopement Alert Form© will be added to the mapping grid as the initial search location. An additional menu item labeled Current/Last Address Location Unknown is available for any/all users who either (a) do not know the last known location of the missing person, or (b) prefer to leave the location anonymous in-lieu-of publishing the remaining content in the pre-registered relational database.

Once the location is appropriately defined, or if the last known location is undeterminable at the time of request, the user can select Continue to proceed to the formal Alert Message.

Once the user selects Continue and proceeds to the formal Alert Message landing page, the following message(s) will be received;
Alert Message
Please fill in the message to send out!
[Message: Free-Form Text Added By Authorized User]
[Send Alert]

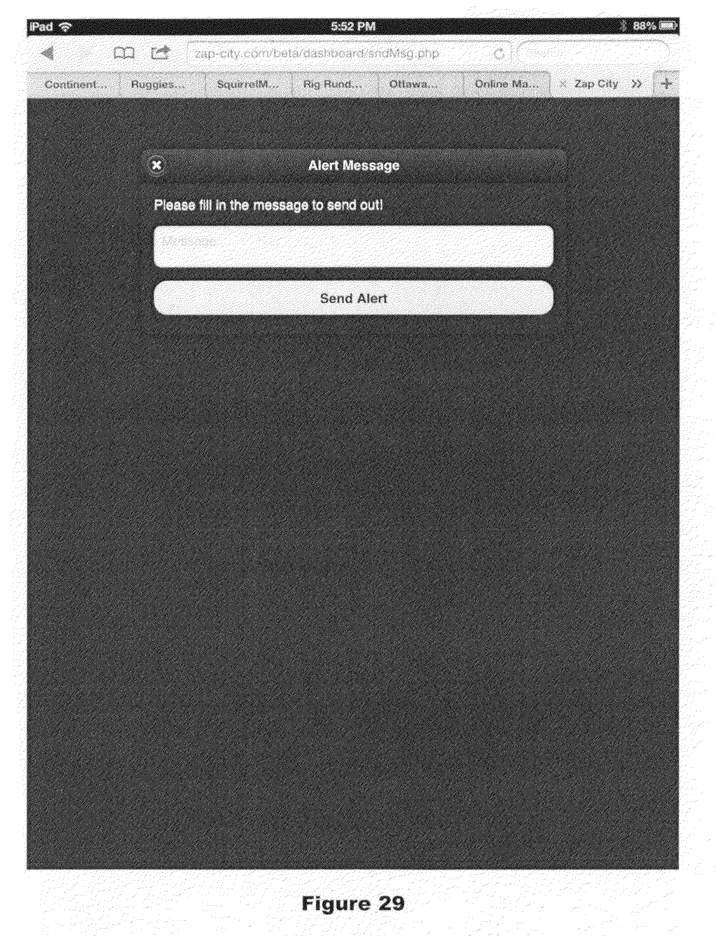

### Please Insert FIG. 29 Here

Once the user selects Send Alert, the following confirmation message will be received;
Alert Message Confirmation
Your message has been sent!
[OK]

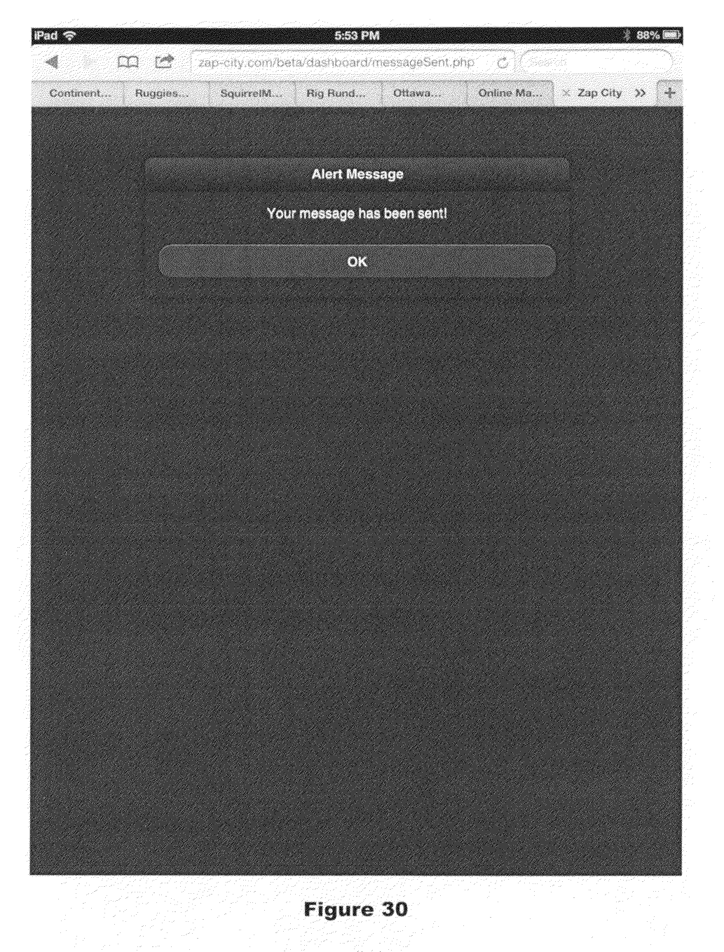

### Please Insert FIG. 30 Here

Once the registered user has sent a formal alert notification, an official email notification will be sent to the registered users preferred (registered/certified) email address showing the following information;

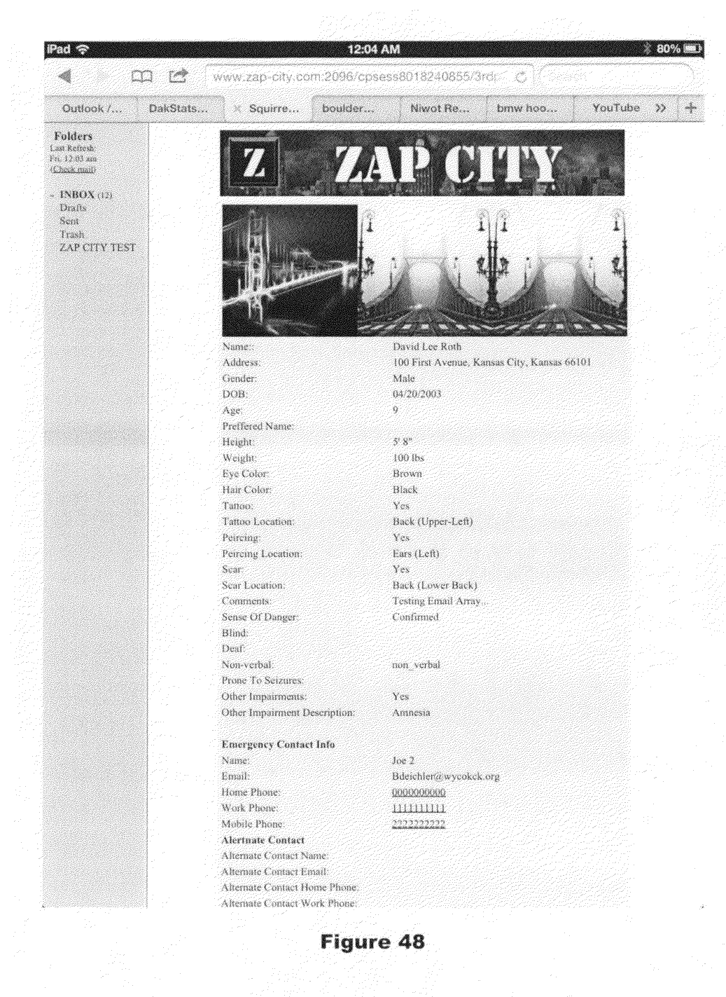

### Please Insert FIG. 48 Here

Please note that the preceding information was utilized as an example of the information only and that the registered user can edit (add/delete/change) the information on file to create a revised notification.

### Language Narration/Description for City Grids Tab:

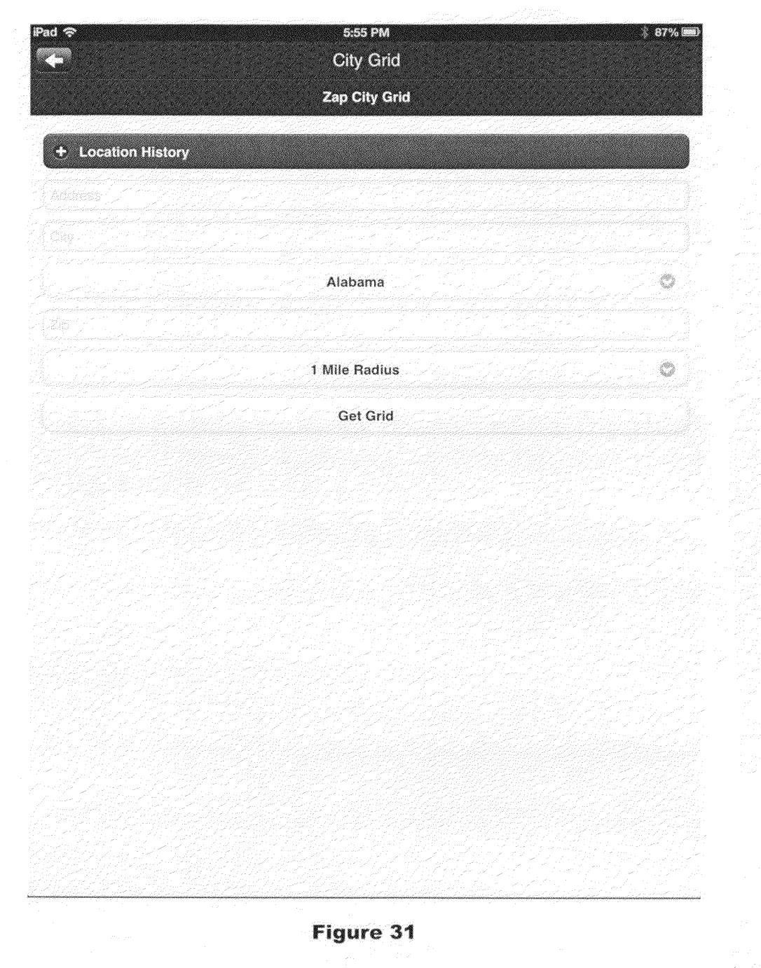

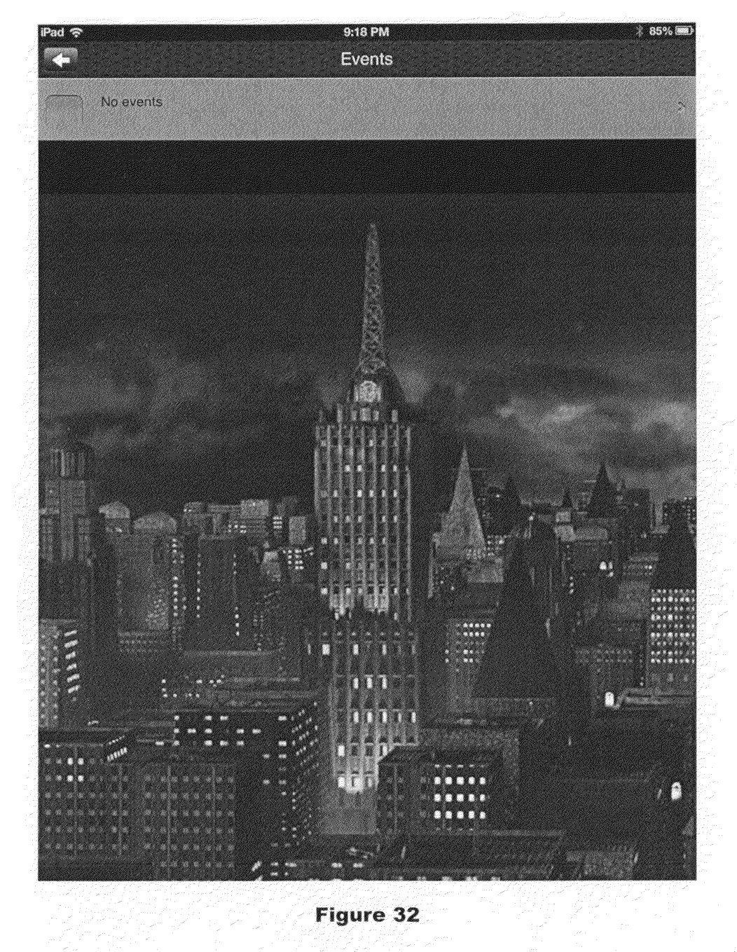

As depicted in FIG. 20 and FIG. 31, the registered user can utilize the City Grids tab to create a specific mapping grid to identify the actual location of the device, or preferred alternate location. Once activated, the Zap City Grid tab will allow the user to either, (a) utilize a drop-down box titled Location History to select a previously entered (historical) location as the current location of choice, or, (b) will allow the user to manually enter a specific location by adding the address, state, and zip code into the form.

### Please Insert FIG. 31 Here

### Mobile Application Workflow when Accessing the City Grid Tab (FIG. 31)

When accessing the City Grid tab, the user can manually enter (Free-Form Text) the current address, city, state, zip code, and in addition, can utilize a drop-down box to select a proprietary grid radius, depicting either a 1, 2, 3, 5, 10, 20, or 50 mile radius, to create a custom mapping grid (location) that will be included as part of the emergency communication(s). Once the information is entered and the user selects Get Grid, an interactive mapping grid is displayed on the device screen and can be utilized to display the point-of-location.

### Please Insert FIG. 27B Here

As previously stated, when using the automated Elopement Alert Form, the user can pre-establish a default location, which in most cases is their home address, and set it as the primary address location. When the user decides to initiate an official emergency alert, the proprietary software solution will ask the user if they need to update the information, or change their location from default to current. Subsequently, the integrated City Grid tab will allow the user to reconfigure the mapping grid if required.

If the user selects the Current Address, they will receive the following screen message;
ADDRESS (w/Free-Form Text Box)
CITY (w/Free-Form Text Box)
STATE (w/Drop-Down Box w/State Selections)
Radius (w/Drop-Down Box listing 1, 2, 3, 5, 10, 20 & 50 Mile Selections)
[GET GRID]

### Please Insert FIG. 31 Here

As a note, this image can be utilized by the Zap City mobile application to establish both a formal location and a flashing beacon at the desired location. Also, the mapping component is interactive, and therefore, the location can be enlarged by zooming-in, reduced by zooming-out, or if the user prefers, the location can be scanned in the North, South, East or West directions by sliding their finger across the device(s) screen.

### Language Narration/Description for Events Tab:

As depicted in both FIG. 20 and FIG. 32, the EVENTS tab allows the user to access any/all information pertaining to upcoming Zap City business events that are formally published to the landing page by the Zap City System Administrator. The information being published will include interactive links to relevant information on the World Wide Web.

### Mobile Application Workflow when Accessing the Events Tab (FIG. 32)

When accessing the Events tab, the user can access the generic information regarding any/all upcoming Zap City LLC events.

If the user selects the Events tab, they will receive the following screen message;
EVENTS
[List of Active Zap City Business Events]

### Please Insert FIG. 32 Here

### Language Narration/Description for City Wall Tab:

As depicted in FIG. 20, the City Wall tab includes general information for registered users to read/review regarding the Zap City applications. If the user selects the City Wall tab, they will receive a screen that allows them to access and/or publish information (blogs, forums, etc.) regarding any/all Zap City search efforts, application development, product information, general communications, or business related information.

### Mobile Application Workflow when Accessing the City Wall Tab

When accessing the City Wall tab, the registered users can access and/or publish general information (e.g. blogs, forums) regarding any/all current Zap City search efforts or general communications. This is an Apple Inc. design feature that allows the registered user to also publish information directly to the Zap City Wall for other registered users to review. Once received, the information will be posted to the City Wall in chronological order and be available for other registered users to peruse. This will also serve as the initial Historical Tracking Log forum and/or publication venue for registered users to track current search criteria.

### Language Narration/Description for More Tab:

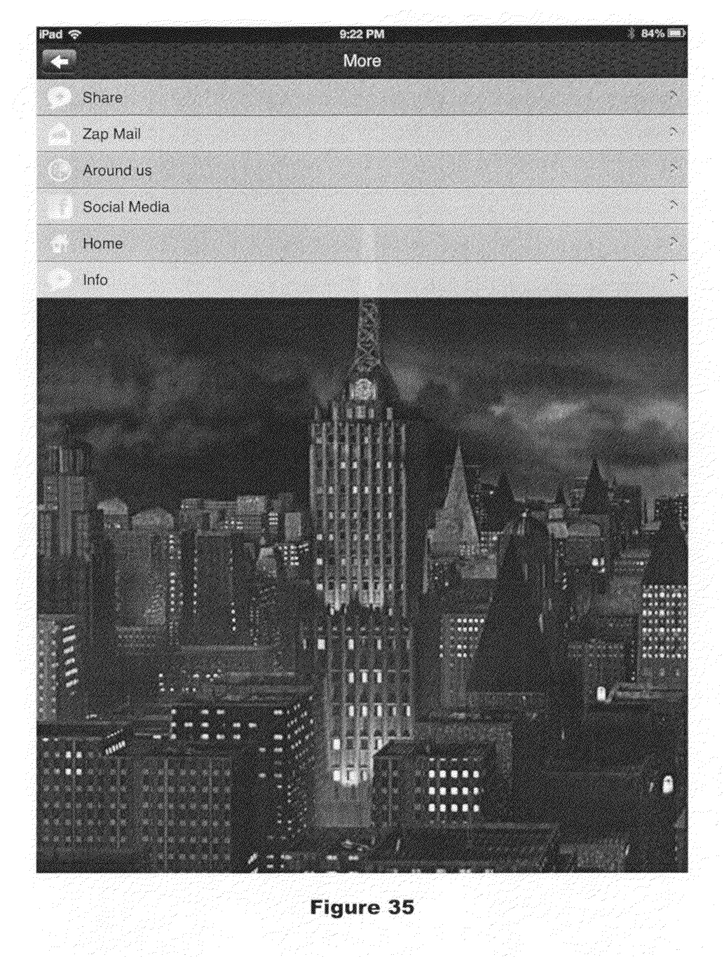

As depicted in both FIG. 20 and FIG. 35, the MORE tab allows the user to share the Zap City mobile application, or their registered data with other registered users and/or persons by social media connection. For example, but not necessarily limited to, the Zap City mobile alert application will allow the user to create a formal notification on Facebook, Twitter, or by email/text, by sending the information to these business associations through an integrated application programming interface (API). The More tab also allows the user to sign-up for Zap City's electronic business mailings (newsletters, etc.), or create a specific mapping grid by entering their current location as previously depicted. Once a specific location is identified, an interactive map is created that depicts a flashing beacon at the specific location.

### Please Insert FIG. 35 Here

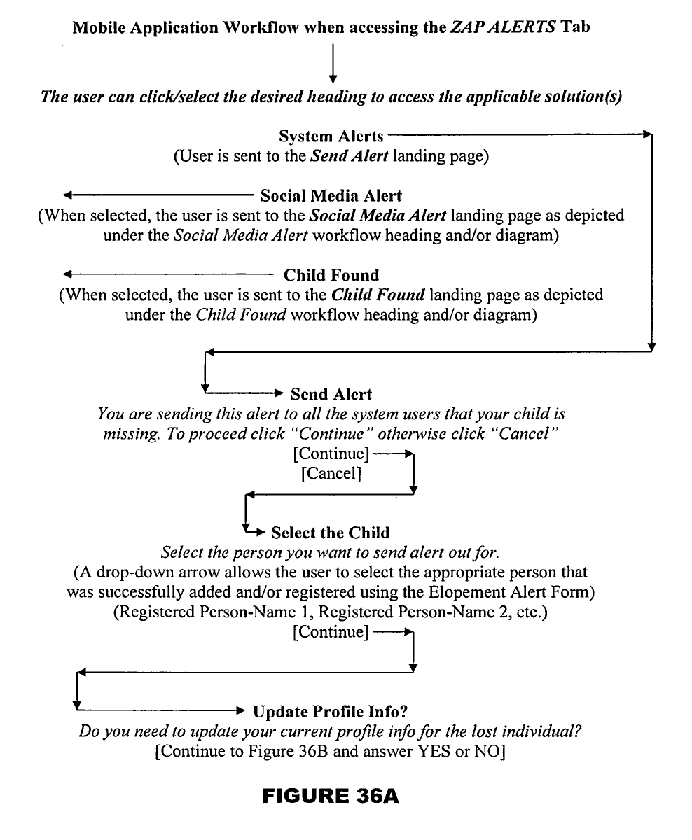

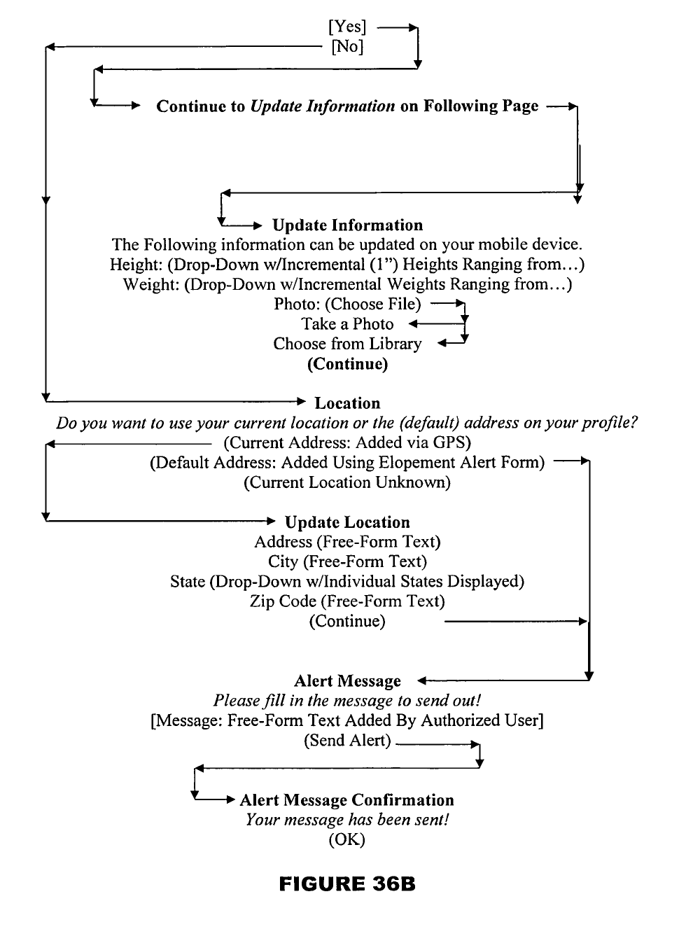

### Mobile Application Workflow when Accessing ZAP ALERTS Tab (FIG. 36A & FIG. 36B)

The user can click/select the desired heading to access the applicable solution(s)
System Alerts
(User is sent to the Send Alert landing page)
Social Media Alert
(When selected, the user is sent to the Social Media Alert landing page as depicted under the Social Media Alert workflow heading and/or diagram)
Child Found
(When selected, the user is sent to the Child Found landing page as depicted under the Child Found workflow heading and/or diagram)
Send Alert (Landing Page)
You are sending this alert to all the system users that your child is missing. To proceed click “Continue” otherwise click “Cancel”
[Continue]
[Cancel]
Select the Child
Select the person you want to send alert out for.
(A drop-down arrow allows the user to select the appropriate person that was successfully added and/or registered using the Elopement Alert Form)
(Registered Person-Name 1, Registered Person-Name 2, etc.)
[Continue]
Update Profile Info?
Do you need to update your current profile info for the lost individual?
[Yes]
[No]
Continue to Update Information on Following Page
Update Information
The Following information can be updated on your mobile device.
Height: (Drop-Down w/Incremental (1″) Heights Ranging from . . . )
Weight: (Drop-Down w/Incremental Weights Ranging from . . . )
Photo: (Choose File)
Take a Photo
Choose from Library
(Continue)
Location
Do you want to use your current location or the (default) address on your profile?
(Current Address: Added via GPS)
Update Location
Address (Free-Form Text)
City (Free-Form Text)
State (Drop-Down w/Individual States Displayed)
Zip Code (Free-Form Text)
(Continue)
(Default Address: Added Using Elopement Alert Form)
(Current Location Unknown)
Alert Message
Please fill in the message to send out!
[Message: Free-Form Text Added By Authorized User]
(Send Alert)
Alert Message Confirmation
Your message has been sent!
(OK)

### Please Insert FIG. 36A Here

### Please Insert FIG. 36B Here

### Language Narration/Description for Zap Pics Tab:

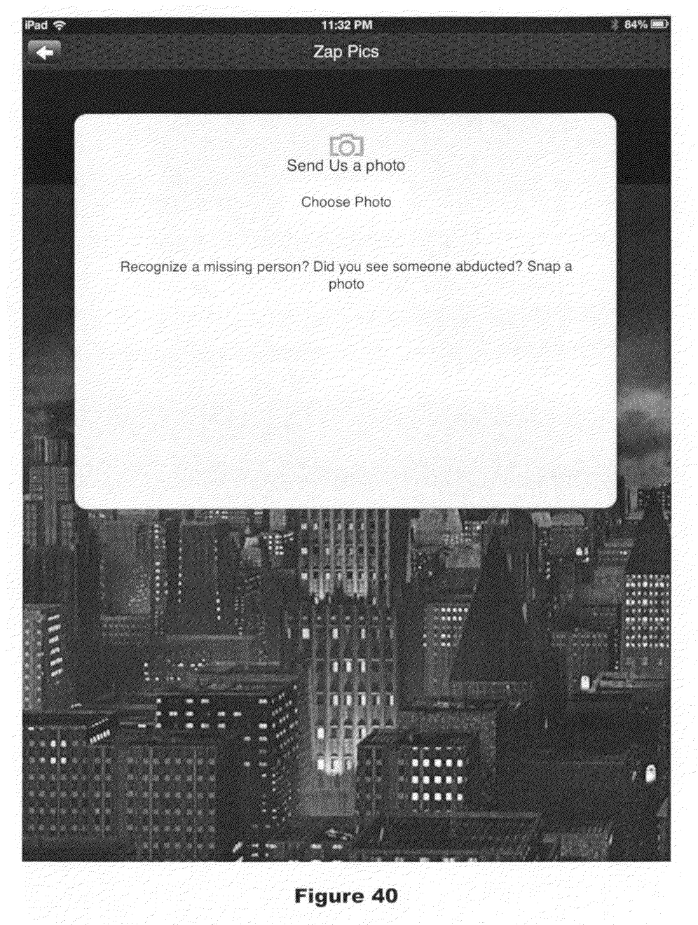

As depicted in both FIG. 20 and FIG. 40, the Zap Pics tab will allow the user to either, (a) create/take a photo and/or video and subsequently upload the information to the Zap City notification website, or, (b) allow the user to locate and/or utilize an existing photo or video on the specific device to upload the information to the Zap City notification website.

### Mobile Application Workflow when Accessing the Zap Pics Tab (FIG. 40)

If the user selects the Zap Pics tab, they will receive the following screen message;
ZAP PICS
Send Us A Photo
[Choose Photo]
Recognize a missing person? Did you see someone abducted? Snap a Photo!

### Please Insert FIG. 40 Here

When the user selects the Choose Photo function, they will be taken to a landing screen that will allow them to either, (a) use the current device to create a photo or video and upload the content to the Zap City website accordingly, or, (b) locate an existing photo or video on the specific device to upload the content to the Zap City website.

If the user selects the Choose Photo tab, they will receive the following screen message;
PHOTOS
[Names of Personal Photo Albums (as stored on current device) Listed Here]
[Names of Personal Photo Albums (as stored on current device) Listed Here]

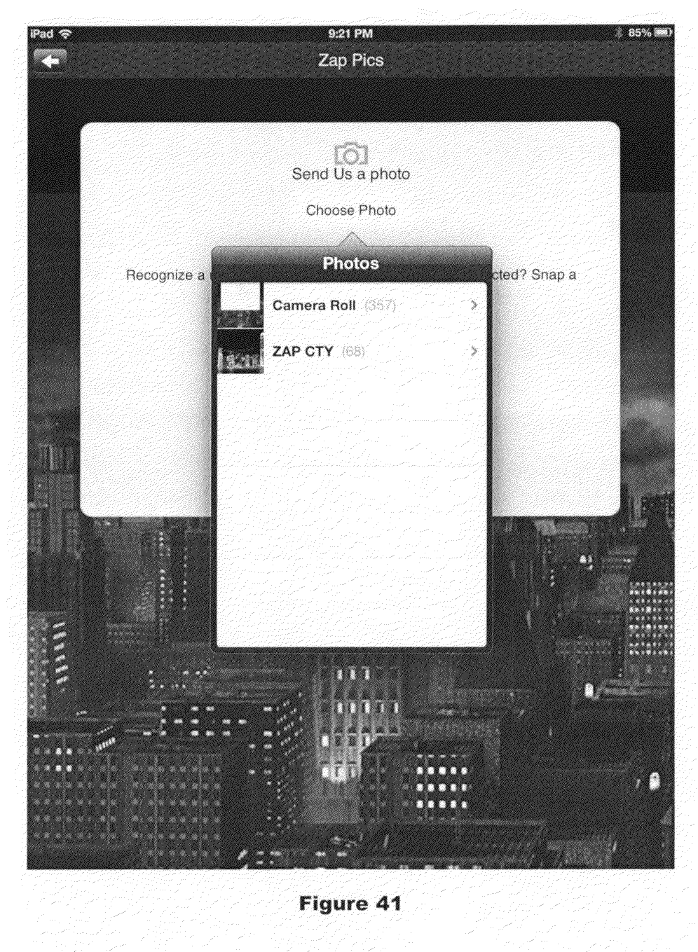

### Please Insert FIG. 41 Here

### Mobile Application Workflow when Accessing the MORE Tab (FIG. 35)

As depicted in both FIG. 20 and FIG. 35, if the user selects the More tab, they will receive the following screen message;
MORE
Share
Zap Mail
Around Us
Social Media
Home
Info

### Please Insert FIG. 35 Here

If the SHARE tab is selected, the integrated workflow model will present the user with the following options;
SHARE
Share by Email
Share on Facebook
Share on Twitter

If the SHARE tab is selected, the integrated workflow model will present the user with the following screen shot;

### Please Insert FIG. 42 Here

If the user selects the Share by Email tab, they are presented with the option to post an email to any/all persons that are selected, including email listings, to receive an informal email notification about the Zap City Mobile App. The default email language is stated as follows;

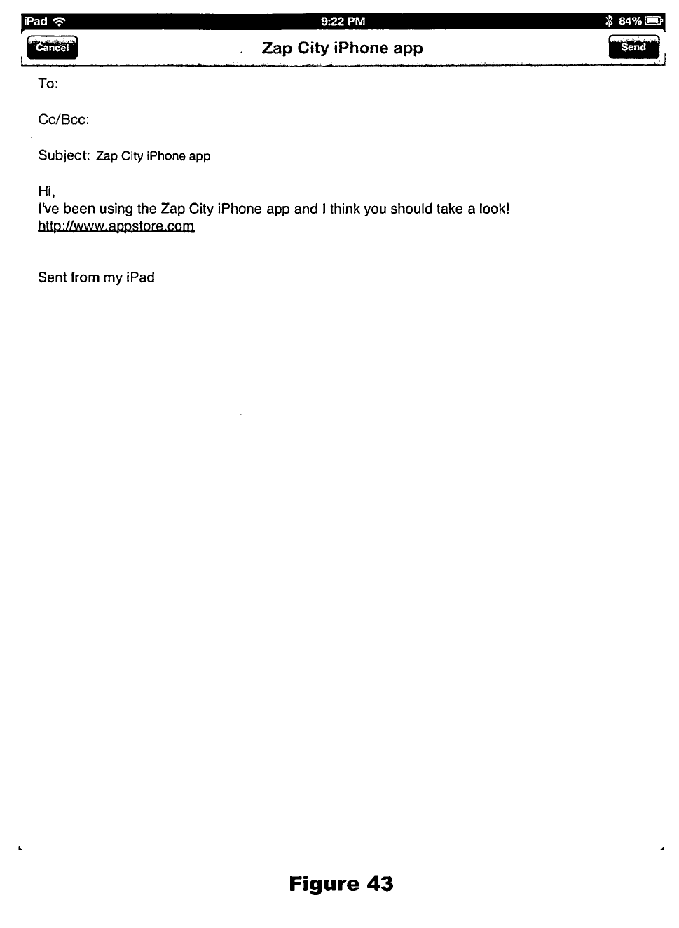

### Please Insert FIG. 43 Here

If the user selects the Share on Facebook tab, they are immediately presented with the option to post a free-form text message, along with the proprietary data elements recorded at the time of registration using the Elopement Alert Form, to their personal Facebook account. Once the user selects the Share on Facebook setting, they will receive the following log-in screen;

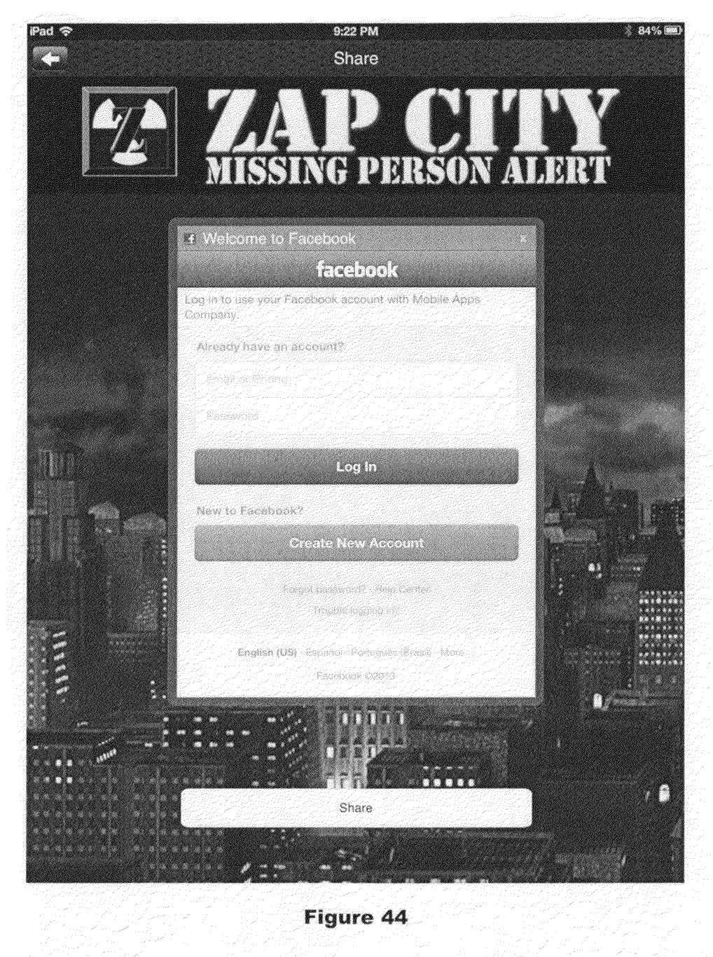

### Please Insert FIG. 44 Here

As with Facebook, if the user selects the Share on Twitter tab, they are immediately presented with the option to post a free-form text message, along with the proprietary data elements recorded at the time of registration using the Zap City Elopement Alert Form©, to their personal Twitter account. Once the user selects the Share on Twitter setting, they will receive the following log-in screen;

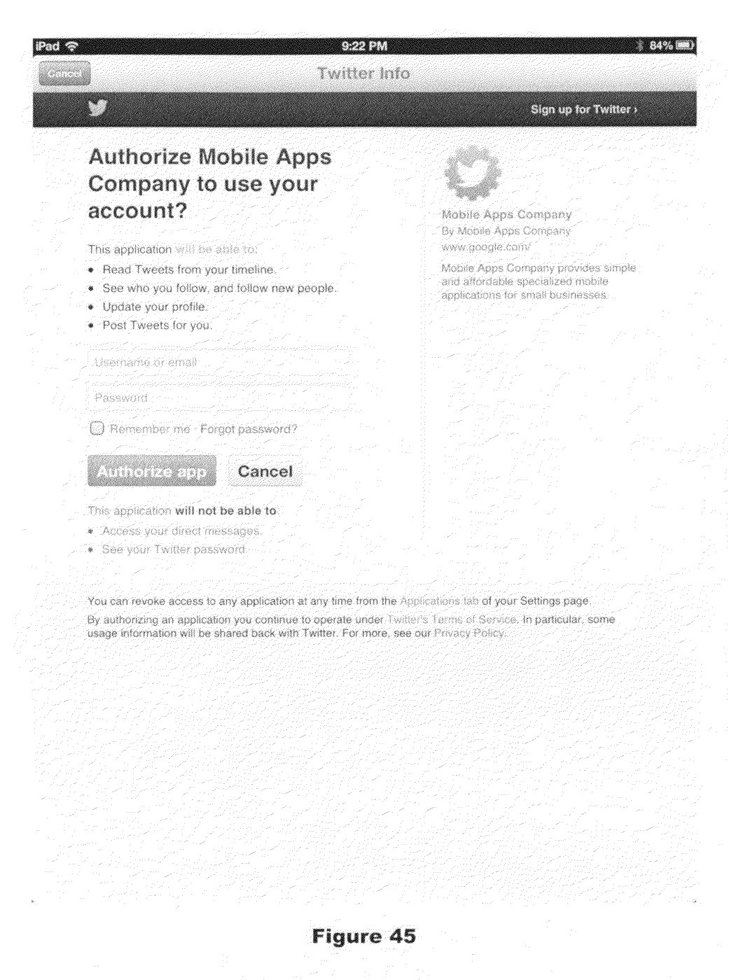

### Please Insert FIG. 45 Here

Please note that once the user identifies their personal log-in information with both Facebook and Twitter, the proprietary software development of the Zap City Mobile Alert App© will remember their sign-in credentials when the user returns to offset the need to continuously log-in upon entry.

The More tab also allows the user to sign-up for Zap City's electronic business mailings, newsletters, etc. If the user selects the More tab, and subsequently selects the Zap Mail tab, the user will be presented with the following screen options;
ZAP MAIL
Sign Up for Our Newsletter
Enter Your Name
Enter Your Email Address
[JOIN]

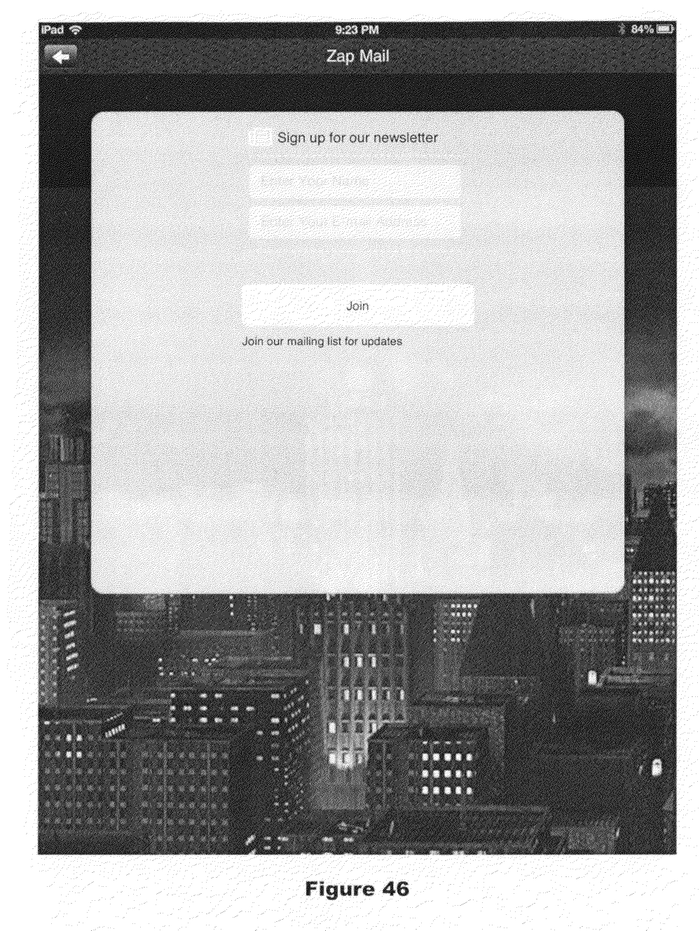

### Please Insert FIG. 46 Here

Once the user accepts the agreement by adding their relevant contact information and joins the Zap City newsletter environment, they will be able to receive updates, push-notices, etc. from Zap City regarding relevant information.

The More tab also allows the user to use an integrated—Proprietary United States Mapping Grid© to identify any/all business locations, etc., that are around their current location. For example, but, not limited to, if the user enters their current location, the Zap City App will allow them to identify a multitude of business locations in the surrounding area. If the user selects the More tab, and subsequently selects the Around Us tab, the user will be presented with the following screen;

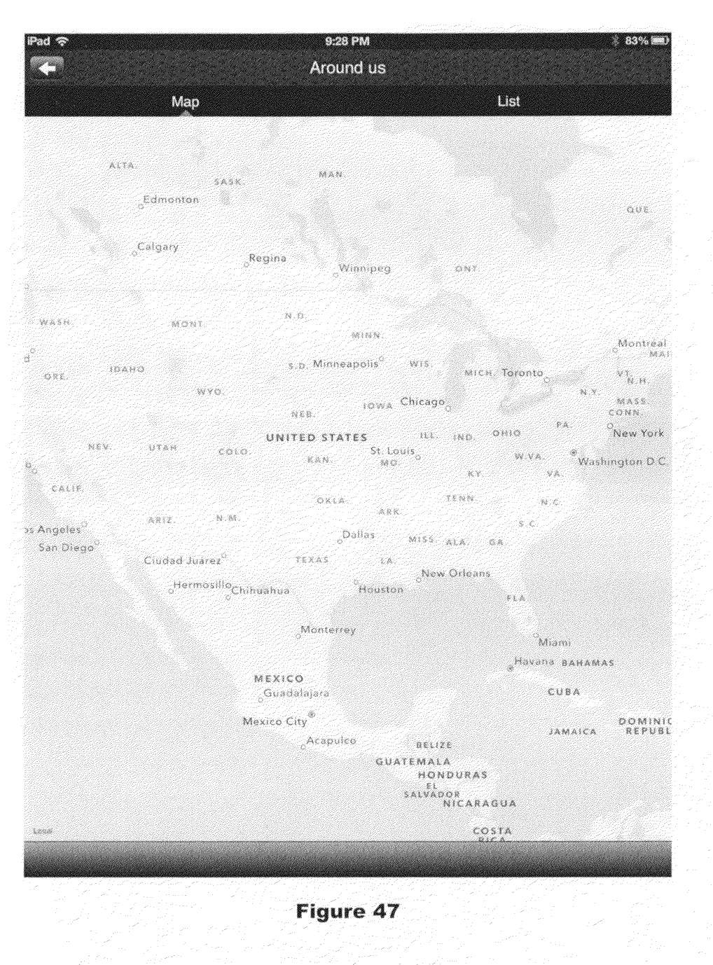

### Please Insert FIG. 47 Here

Once the mapping grid is presented, a flashing beacon will signal the exact location that was entered. Also, the user will be able to utilize the interactive mapping grid to move North, South, East, or West, and, will also allow the user to zoom-in to enlarge the location, or zoom-out to reduce the location by touching the screen.

What is claimed is:

1. A proprietary development code that is architecturally developed and aligned with integrated, open-source, communication and mapping technologies to improve real-time emergency search communications amongst registered system and software users that is comprised of;
a. PHP, IOS, AJAX, HTML, JSON, and MySQL database technologies.
b. integrated, open-source communication and mapping technologies.

2. The architectural systems and business processes of claim 1, wherein the proprietary development code is specifically aligned with existing open-source and custom technology languages to create a specific business methodology comprising; custom development code, custom database forms and files, open-source communication and mapping technologies, and specifically developed and aligned business communication processes to increase the utilitarian search efforts of registered system users when a formal missing person alert is created and published using the proprietary Zap City Missing Persons Alert© system.

3. The architectural systems and business processes of claim 2, wherein the proprietary development code is proprietarily developed and aligned with open-source mapping technologies to improve real-time, electronically-driven emergency search communications amongst registered system and software users that is comprised of;
a. a proprietarily integrated, open-source mapping grid that includes specific development code (e.g. PHP, IOS, AJAX, HTML, JSON, and MySQL database technologies) that is proprietarily developed and aligned to improve real-time emergency search communications amongst registered system users, and to also allow the end-user to create and distribute an electronic map with proprietarily embedded data elements, specific boundaries, and pre-defined mapping radii as detailed in FIGS. 1, 2, 3, and 4 in the background, brief summary, detailed description, drawings, claims and abstract sections for this invention.

4. The architectural systems and business processes of claim 2, wherein a utility-based communication process using open-source architecture, proprietary development code, copyrighted business forms and electronic files, integrated mapping components, and specific business workflow methodologies, and, as also defined in the background, brief summary, detailed description, drawings, claims and abstract sections for this invention, is created for distributing electronic information to registered system users that comprises at least one data file, the electronic communication process for this claim is comprised of;
a. the end-user accessing the business website, downloading the proprietarily developed software code using an electronic device, a computer, a mobile laptop computer, or mobile peripheral device, utilizing the proprietary software code and copyrighted forms to complete the initial registration process and saving the information for future access, distribution, or publication, to effectively allow the end-user the ability to create an electronic search process and disseminate the proprietary information or electronic files to registered support personnel and registered users when a formal search request is published using the system.
b. the proprietarily developed architecture integrating with existing electronic open-source communication technologies and global positioning systems (GPS) and geo-positional mapping technologies to allow the proprietary development coding to complete the required communication processes during the initial registration process, system updates, unilateral and bilateral communication exchanges from the end-user, or emergency search alert process.
c. an integrated mapping component depicting current open-source data, proprietarily embedded—copyrighted signage icons, defined search radii, information pertaining to historical event statistics for individual people or groups of people with similar tendencies, and proprietary alpha-numeric grid lines, grid boundaries and central-points-of-location as assigned by the registered user or open-source communications.
d. the development and architectural alignment of statistical-based algorithms within the development code that allows the automated system to mathematically determine the probability ratio's and risk profiles of individual people in a specified mapping area before, during, and after targeted search events, and also allow the registered users to identify and review the historical tracking elements of a specific search area.
e. the end-user receiving an electronic communication with an interactive historical tracking log depicting both group and independent communication updates from registered users and current search personnel to support specific processes for identified search personnel during a formal search event.

5. The architectural systems and proprietary business processes of claim 4, comprising;
a. a proprietary development code that allows the end-user to access the initial Zap City Elopement Alert Form© (FIG. 7), to formally register proprietarily required information for any/all preferred people by inputting specific information into the required fields using an electronic device, computer, or mobile peripheral device, and saving the information to a relational database or individual device for future access, distribution, or publication during an emergency search event using the proprietary business and computer software processes as defined in the background, brief summary, detailed description, drawings, claims and abstract sections for this invention.

6. The architectural systems and proprietary business processes of claim 4, comprising;
a. the electronic identification and subsequent communication of open-source global positioning systems and satellites (GPSS) and geo-positional mapping coordinates that are specifically utilized by the proprietarily developed software code to enhance the integrated communication workflow and dynamic mapping grid elements when a formal emergency search is published.

7. The architectural systems and proprietary business processes of claim 4, comprising;
a. an interactive, integrated mapping component depicting current open-source data, proprietarily embedded—copyrighted signage icons as defined in the background, brief summary, detailed description, drawings, claims and abstract sections for this invention, and any/all proprietarily assigned alpha-numeric grid lines, boundaries, search radii and central-points-of-location as preliminarily defined and assigned by the registered user.

8. The architectural systems and proprietary business processes of claim 4, comprising;
a. an interactive, integrated mapping component depicting specific grid locations, search radii, and information pertaining to historical event statistics for individual people or groups of people with similar tendencies, as defined by specific electronic open-source research requests, automatically embedded electronic open-source mapping technologies and mapping data, proprietary mathematically-based business algorithms, and specific data elements that can be manually input by the individual registered users for a targeted search area.

9. The architectural systems and proprietary business processes of claim 1, wherein the proprietary development code is specifically aligned with additional open-source technologies to create specific business methodologies comprising;
a. a proprietary mapping grid as defined in the background, brief summary, detailed description, drawings, claims and abstract sections for this invention, and the technologies and business processes as specifically defined in FIGS. 1 & 2.
b. proprietary signage icons as defined in the background, brief summary, detailed description, drawings, claims and abstract sections for this invention, and the technologies and business processes as specifically defined in FIG. 3.
c. a Proprietary United States Mapping Grid© as defined in the background, brief summary, detailed description, drawings, claims and abstract sections for this invention, and the technologies and business processes, and specific State prefix codes as specifically defined in FIG. 4.
d. a Proprietary United States Boundary Map© as defined in the background, brief summary, detailed description, drawings, claims and abstract sections for this invention, and the technologies and business processes, and specific State prefix codes as specifically defined in FIG. 5.
e. a proprietary Unique Search/Event Code User's Template© as defined in the background, brief summary, detailed description, drawings, claims and abstract sections for this invention, and the technologies and business processes, and specific event codes as specifically defined in FIG. 6.
f. a proprietary Elopement Alert Form© as defined in the background, brief summary, detailed description, drawings, claims and abstract sections for this invention, and the technologies, business processes, and proprietary demographics as specifically defined in FIG. 7.
g. a proprietary development code supporting both the technology and business workflow processes of the Zap City Missing Person's Application as defined in the background, brief summary, detailed description, drawings, claims and abstract sections for this invention, and the specific technologies, business processes, and specific language supporting the Zap City Missing Person's Alert Application© technology as specifically defined in:
i. FIG. 1: Static Zap Map with Boundaries and sectors
ii. FIG. 2: Dynamic Zap Map with Boundaries and Sectors
iii. FIG. 3: Proprietary Signage and Mapping Icons
iv. FIG. 4: Proprietary United States Mapping Grid©
v. FIG. 5: Zap City Proprietary United States Boundary Map©
vi. FIG. 6: Unique Search/Event Code User's Template©
vii. FIG. 7: Zap City Elopement Alert Form©
viii. FIG. 18: Architectural Workflow Diagram
ix. FIG. 19: Zap City Multi-Contact Platform
x. FIG. 20: Zap City Missing Person Alert Landing Page
xi. FIG. 21: Zap City “Log-In” Page
xii. FIG. 22: Zap City “Systems Alert” Page
xiii. FIG. 23: Zap City “Send Alert” Page
xiv. FIG. 24: Zap City “Select the Child” Page
xv. FIG. 25: Zap City “Update Profile Info (Yes/No)” Page
xvi. FIG. 26: Zap City “Update Info (Height/Weight/Photo)” Page
xvii. FIG. 27A: Zap City “Location (Current/Default)” Page
xviii. FIG. 27B: Zap City “City Grid” Mapping Page
xix. FIG. 28: Zap City “Location (Address/City/State/Zip)” Page
xx. FIG. 29: Zap City “Alert Message/Send Alert” Page
xxi. FIG. 30: Zap City “Alert Message Sent” Page
xxii. FIG. 31: Zap City “City Grid” Selection Page
xxiii. FIG. 32: Zap City “Events” Page
xxiv. FIG. 35: Zap City “More” Page
xxv. FIG. 36A: Zap City “Mobile Applications Workflow Alerts Tab” Diagram
xxvi. FIG. 36B: Zap City “Mobile Applications Workflow Alerts Tab” (Cont′d)
xxvii. FIG. 40: Zap City “Zap Pics Choose Photo” Page
xxviii. FIG. 41: Zap City “Zap Pics Photos Drop Down” Page
xxix. FIG. 42: Zap City “Share by Social Media” Page
xxx. FIG. 43: Zap City “Share by Email” Page
xxxi. FIG. 44: Zap City “Share by Social Media” Page
xxxii. FIG. 45: Zap City “Twitter Log-In” Page
xxxiii. FIG. 46: Zap City “Zap Mail Sign Up for Our Newsletter” Page
xxxiv. FIG. 47: Zap City “Around Us” Page
xxxv. FIG. 48: Zap City “Integrated Zap City Emergency Email Notification Message” Page
xxxvi. FIG. 49: Zap City “Formal Zap City Email Registration Notice” Page

10. The architectural systems and proprietary business processes of claim 2, wherein the proprietary development code is specifically aligned with additional open-source technologies to create specific business methodologies comprising;
a. a proprietary mapping grid as defined in the background, brief summary, detailed description, drawings, claims and abstract sections for this invention, and the technologies and business processes as specifically defined in FIGS. 1 & 2.
b. proprietary signage icons as defined in the background, brief summary, detailed description, drawings, claims and abstract sections for this invention, and the technologies and business processes as specifically defined in FIG. 3.
c. a Proprietary United States Mapping Grid© as defined in the background, brief summary, detailed description, drawings, claims and abstract sections for this invention, and the technologies and business processes, and specific State prefix codes as specifically defined in FIG. 4.
d. a Proprietary United States Boundary Map© as defined in the background, brief summary, detailed description, drawings, claims and abstract sections for this invention, and the technologies and business processes, and specific State prefix codes as specifically defined in FIG. 5.
e. a proprietary Unique Search/Event Code User's Template© as defined in the background, brief summary, detailed description, drawings, claims and abstract sections for this invention, and the technologies and business processes, and specific event codes as specifically defined in FIG. 6.
f. a proprietary Elopement Alert Form© as defined in the background, brief summary, detailed description, drawings, claims and abstract sections for this invention, and the technologies, business processes, and proprietary demographics as specifically defined in FIG. 7.
g. a proprietary development code supporting both the technology and business workflow processes of the Zap City Missing Person's Application© as defined in the background, brief summary, detailed description, drawings, claims and abstract sections for this invention, and the specific technologies, business processes, and specific language supporting the Zap City Missing Person's Alert Application© technology as specifically defined in:
i. FIG. 1: Static Zap Map with Boundaries and sectors
ii. FIG. 2: Dynamic Zap Map with Boundaries and Sectors
iii. FIG. 3: Proprietary Signage and Mapping Icons
iv. FIG. 4: Proprietary United States Mapping Grid©
v. FIG. 5: Zap City Proprietary United States Boundary Map©
vi. FIG. 6: Unique Search/Event Code User's Template©
vii. FIG. 7: Zap City Elopement Alert Form©
viii. FIG. 18: Architectural Workflow Diagram
ix. FIG. 19: Zap City Multi-Contact Platform
x. FIG. 20: Zap City Missing Person Alert Landing Page
xi. FIG. 21: Zap City “Log-In” Page
xii. FIG. 22: Zap City “Systems Alert” Page
xiii. FIG. 23: Zap City “Send Alert” Page
xiv. FIG. 24: Zap City “Select the Child” Page
xv. FIG. 25: Zap City “Update Profile Info (Yes/No)” Page
xvi. FIG. 26: Zap City “Update Info (Height/Weight/Photo)” Page
xvii. FIG. 27A: Zap City “Location (Current/Default)” Page
xviii. FIG. 27B: Zap City “City Grid” Mapping Page
xix. FIG. 28: Zap City “Location (Address/City/State/Zip)” Page
xx. FIG. 29: Zap City “Alert Message/Send Alert” Page
xxi. FIG. 30: Zap City “Alert Message Sent” Page
xxii. FIG. 31: Zap City “City Grid” Selection Page
xxiii. FIG. 32: Zap City “Events” Page
xxiv. FIG. 35: Zap City “More” Page
xxv. FIG. 36A: Zap City “Mobile Applications Workflow Alerts Tab” Diagram
xxvi. FIG. 36B: Zap City “Mobile Applications Workflow Alerts Tab” (Cont′d)
xxvii. FIG. 40: Zap City “Zap Pics Choose Photo” Page
xxviii. FIG. 41: Zap City “Zap Pics Photos Drop Down” Page
xxix. FIG. 42: Zap City “Share by Social Media” Page
xxx. FIG. 43: Zap City “Share by Email” Page
xxxi. FIG. 44: Zap City “Share by Social Media” Page
xxxii. FIG. 45: Zap City “Twitter Log-In” Page
xxxiii. FIG. 46: Zap City “Zap Mail Sign Up for Our Newsletter” Page
xxxiv. FIG. 47: Zap City “Around Us” Page
xxxv. FIG. 48: Zap City “Integrated Zap City Emergency Email Notification Message” Page
xxxvi. FIG. 49: Zap City “Formal Zap City Email Registration Notice” Page

11. The architectural systems and proprietary business processes of claim 3, wherein the proprietary development code is specifically aligned with additional open-source technologies to create specific business methodologies comprising;
a. a proprietary mapping grid as defined in the background, brief summary, detailed description, drawings, claims and abstract sections for this invention, and the technologies and business processes as specifically defined in FIGS. 1 & 2.
b. proprietary signage icons as defined in the background, brief summary, detailed description, drawings, claims and abstract sections for this invention, and the technologies and business processes as specifically defined in FIG. 3.
c. a Proprietary United States Mapping Grid as defined in the background, brief summary, detailed description, drawings, claims and abstract sections for this invention, and the technologies and business processes, and specific State prefix codes as specifically defined in FIG. 4.
d. a Proprietary United States Boundary Map© as defined in the background, brief summary, detailed description, drawings, claims and abstract sections for this invention, and the technologies and business processes, and specific State prefix codes as specifically defined in FIG. 5.
e. a proprietary Unique Search/Event Code User's Template© as defined in the background, brief summary, detailed description, drawings, claims and abstract sections for this invention, and the technologies and business processes, and specific event codes as specifically defined in FIG. 6.
f. a proprietary Elopement Alert Form© as defined in the background, brief summary, detailed description, drawings, claims and abstract sections for this invention, and the technologies, business processes, and proprietary demographics as specifically defined in FIG. 7.
g. a proprietary development code supporting both the technology and business workflow processes of the Zap City Missing Person's Application© as defined in the background, brief summary, detailed description, drawings, claims and abstract sections for this invention, and the specific technologies, business processes, and specific language supporting the Zap City Missing Person's Alert Application© technology as specifically defined in:
i. FIG. 1: Static Zap Map with Boundaries and sectors
ii. FIG. 2: Dynamic Zap Map with Boundaries and Sectors
iii. FIG. 3: Proprietary Signage and Mapping Icons
iv. FIG. 4: Proprietary United States Mapping Grid©
v. FIG. 5: Zap City Proprietary United States Boundary Map©
vi. FIG. 6: Unique Search/Event Code User's Template©
vii. FIG. 7: Zap City Elopement Alert Form©
viii. FIG. 18: Architectural Workflow Diagram
ix. FIG. 19: Zap City Multi-Contact Platform
x. FIG. 20: Zap City Missing Person Alert Landing Page
xi. FIG. 21: Zap City “Log-In” Page
xii. FIG. 22: Zap City “Systems Alert” Page
xiii. FIG. 23: Zap City “Send Alert” Page
xiv. FIG. 24: Zap City “Select the Child” Page
xv. FIG. 25: Zap City “Update Profile Info (Yes/No)” Page
xvi. FIG. 26: Zap City “Update Info (Height/Weight/Photo)” Page
xvii. FIG. 27A: Zap City “Location (Current/Default)” Page
xviii. FIG. 27B: Zap City “City Grid” Mapping Page
xix. FIG. 28: Zap City “Location (Address/City/State/Zip)” Page
xx. FIG. 29: Zap City “Alert Message/Send Alert” Page
xxi. FIG. 30: Zap City “Alert Message Sent” Page
xxii. FIG. 31: Zap City “City Grid” Selection Page
xxiii. FIG. 32: Zap City “Events” Page
xxiv. FIG. 35: Zap City “More” Page
xxv. FIG. 36A: Zap City “Mobile Applications Workflow Alerts Tab” Diagram
xxvi. FIG. 36B: Zap City “Mobile Applications Workflow Alerts Tab” (Cont′d)
xxvii. FIG. 40: Zap City “Zap Pics Choose Photo” Page
xxviii. FIG. 41: Zap City “Zap Pics Photos Drop Down” Page
xxix. FIG. 42: Zap City “Share by Social Media” Page
xxx. FIG. 43: Zap City “Share by Email” Page
xxxi. FIG. 44: Zap City “Share by Social Media” Page
xxxii. FIG. 45: Zap City “Twitter Log-In” Page
xxxiii. FIG. 46: Zap City “Zap Mail Sign Up for Our Newsletter” Page
xxxiv. FIG. 47: Zap City “Around Us” Page
xxxv. FIG. 48: Zap City “Integrated Zap City Emergency Email Notification Message” Page
xxxvi. FIG. 49: Zap City “Formal Zap City Email Registration Notice” Page

12. The architectural systems and proprietary business processes of claim 4, wherein the proprietary development code is specifically aligned with additional open-source technologies to create specific business methodologies comprising;
a. a proprietary mapping grid as defined in the background, brief summary, detailed description, drawings, claims and abstract sections for this invention, and the technologies and business processes as specifically defined in FIGS. 1 & 2.
b. proprietary signage icons as defined in the background, brief summary, detailed description, drawings, claims and abstract sections for this invention, and the technologies and business processes as specifically defined in FIG. 3.
c. a Proprietary United States Mapping Grid© as defined in the background, brief summary, detailed description, drawings, claims and abstract sections for this invention, and the technologies and business processes, and specific State prefix codes as specifically defined in FIG. 4.
d. a Proprietary United States Boundary Map© as defined in the background, brief summary, detailed description, drawings, claims and abstract sections for this invention, and the technologies and business processes, and specific State prefix codes as specifically defined in FIG. 5.
e. a proprietary Unique Search/Event Code User's Template© as defined in the background, brief summary, detailed description, drawings, claims and abstract sections for this invention, and the technologies and business processes, and specific event codes as specifically defined in FIG. 6.
f. a proprietary Elopement Alert Form© as defined in the background, brief summary, detailed description, drawings, claims and abstract sections for this invention, and the technologies, business processes, and proprietary demographics as specifically defined in FIG. 7.
g. a proprietary development code supporting both the technology and business workflow processes of the Zap City Missing Person's Application© as defined in the background, brief summary, detailed description, drawings, claims and abstract sections for this invention, and the specific technologies, business processes, and specific language supporting the Zap City Missing Person's Alert Application© technology as specifically defined in:
i. FIG. 1: Static Zap Map with Boundaries and sectors
ii. FIG. 2: Dynamic Zap Map with Boundaries and Sectors
iii. FIG. 3: Proprietary Signage and Mapping Icons
iv. FIG. 4: Proprietary United States Mapping Grid©
v. FIG. 5: Zap City Proprietary United States Boundary Map
vi. FIG. 6: Unique Search/Event Code User's Template
vii. FIG. 7: Zap City Elopement Alert Form 0
viii. FIG. 18: Architectural Workflow Diagram
ix. FIG. 19: Zap City Multi-Contact Platform
x. FIG. 20: Zap City Missing Person Alert Landing Page
xi. FIG. 21: Zap City “Log-In” Page
xii. FIG. 22: Zap City “Systems Alert” Page
xiii. FIG. 23: Zap City “Send Alert” Page
xiv. FIG. 24: Zap City “Select the Child” Page
xv. FIG. 25: Zap City “Update Profile Info (Yes/No)” Page
xvi. FIG. 26: Zap City “Update Info (Height/Weight/Photo)” Page
xvii. FIG. 27A: Zap City “Location (Current/Default)” Page
xviii. FIG. 27B: Zap City “City Grid” Mapping Page
xix. FIG. 28: Zap City “Location (Address/City/State/Zip)” Page
xx. FIG. 29: Zap City “Alert Message/Send Alert” Page
xxi. FIG. 30: Zap City “Alert Message Sent” Page
xxii. FIG. 31: Zap City “City Grid” Selection Page
xxiii. FIG. 32: Zap City “Events” Page
xxiv. FIG. 35: Zap City “More” Page
xxv. FIG. 36A: Zap City “Mobile Applications Workflow Alerts Tab” Diagram
xxvi. FIG. 36B: Zap City “Mobile Applications Workflow Alerts Tab” (Cont′d)
xxvii. FIG. 40: Zap City “Zap Pics Choose Photo” Page
xxviii. FIG. 41: Zap City “Zap Pics Photos Drop Down” Page
xxix. FIG. 42: Zap City “Share by Social Media” Page
xxx. FIG. 43: Zap City “Share by Email” Page
xxxi. FIG. 44: Zap City “Share by Social Media” Page
xxxii. FIG. 45: Zap City “Twitter Log-In” Page
xxxiii. FIG. 46: Zap City “Zap Mail Sign Up for Our Newsletter” Page
xxxiv. FIG. 47: Zap City “Around Us” Page
xxxv. FIG. 48: Zap City “Integrated Zap City Emergency Email Notification Message” Page
xxxvi. FIG. 49: Zap City “Formal Zap City Email Registration Notice” Page
